(19) United States
(12) Patent Application Publication
(10) Pub. No.: US 2026/0073139 A1
(43) Pub. Date: Mar. 12, 2026

(54) ADAPTIVE FRAMEWORK FOR MULTI-ENTITY DETECTION, DATA SOURCING, AND INTERCOMPANY PROCESSING

(71) Applicant: ORACLE INTERNATIONAL CORPORATION, Redwood Shores, CA (US)

(72) Inventors: Shyam Sundar SANTHANAM, Dublin, CA (US); Francesca W. AMEZQUITA, San Bruno, CA (US); Sundar NARAYANAN, Belmont, CA (US); Josefina BRADBURY, Bay Harbor Islands, FL (US); Mannu SACHDEVA, Noida (IN); Ashish KUMAR, Belmont, CA (US); Saurabh KUMAR, Hyderabad (IN); Mani Kanth NANDA, Hyderabad (IN)

(21) Appl. No.: 19/320,014

(22) Filed: Sep. 5, 2025

Related U.S. Application Data
(60) Provisional application No. 63/692,051, filed on Sep. 7, 2024.

(51) Int. Cl. G06F 40/279; G06N 5/04; G06N 7/01; G06Q 20/40; G06Q 40/02

(52) U.S. Cl. CPC G06F 40/279; G06N 5/04; G06N 7/01; G06Q 20/401; G06Q 40/02

(57) ABSTRACT

Systems, methods, and other embodiments associated with a framework for multi-entity detection, data sourcing, and processing are described. In one embodiment, a multi-entity processing method includes parsing an electronic document being processed in a processing flow for a first entity to detect that the document also concerns a second entity based on entity identifiers in the document. In response to the detection, the method determines an inter-entity agreement that governs processing between the first entity and second entity by matching attributes of the document against stored agreement data structures. The method automatically orchestrates processing of an inter-entity transaction between the first entity and the second entity by generating execution steps according to sequential and parallel dependencies specified by the inter-entity agreement. And, the method generates electronic records in a system of the first entity and a system of the second entity that reflect execution of the inter-entity transaction.

### CROSS REFERENCE TO RELATED APPLICATIONS

This disclosure claims the benefit of U.S. Provisional patent application Ser. No. 63/692,051 filed Sep. 7, 2024, titled “INTERCOMPANY DOCUMENT PREPARATION SYSTEM,” having inventors: Shyam Sundar SANTHANAM, Francesca W. AMEZQUITA, Sundar NARAYANAN, Josefina BRADBURY, Mannu SACHDEVA, Ashish KUMAR, Saurabh KUMAR, and Mani Kanth NANDA, and assigned to the present assignee, which is incorporated by reference herein in its entirety.

### BACKGROUND

Existing systems have documents in many formats that cannot be read consistently by computing systems. The heterogeneous document formats prevent uniform parsing.

Existing systems do not detect multi-party involvement until late in processing, which wastes computing resources. The lack of early detection prevents branch flows from being initiated promptly.

Existing systems create duplicate submissions that corrupt stored data across computing systems. The absence of idempotent processing causes retries and partial writes to produce conflicting records.

Existing systems have workflows that deadlock because task order is not explicit. The absence of a machine-readable ordering structure causes circular dependencies in processing tasks.

Existing systems execute tasks sequentially and fail to exploit modern multi-core processors. The absence of parallel task dispatch prevents independent steps from running concurrently.

Existing systems lack accurate, consistent matching between document attributes and stored agreements, which can produce conflicting results, leading to errors across connected systems.

Existing systems do not consider reliability of machine learning outputs. The absence of confidence scores means inferred values can be stored even when inaccurate.

In existing systems, accessing data from external systems to prepare the document imposes blocking requirements on the external systems that stop operation of external processes until all data attributes for preparing the document are collected, causing substantial processing delays to the blocked systems. Existing systems may thus block entire workflows when input data is incomplete. Pipelines stall because no mechanism exists to defer and resume processing.

Existing systems may duplicate processing, which creates multiple records for the same transaction. The lack of lineage tracking causes retries to generate divergent outputs.

Existing systems make unexplained decisions, and outputs cannot be traced.

Existing systems waste processing cycles and generate unnecessary network traffic with redundant and/or incomplete submissions.

Existing systems are unable to operate on partially ingested data, potentially delaying a primary processing of a document while awaiting data to perform a secondary processing.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a multi-entity processing system that is associated with autonomous preparation of inter-entity electronic documents.

FIG. 2 illustrates one embodiment of a multi-entity processing method that is associated with autonomous preparation of inter-entity electronic documents.

FIG. 3 illustrates one example process flow for cross-charge treatment of AP invoices that does not use the multi-entity processing method.

FIG. 4 illustrates another example process flow for cross-charge treatment of AP invoices that does use the multi-entity processing system, which is associated with autonomous preparation of inter-entity electronic documents.

FIG. 5 illustrates an example data flow for cross-charge treatment of AP invoices that incorporates the multi-entity processing system, which is associated with autonomous preparation of inter-entity electronic documents.

FIG. 6 illustrates a high-level solution flow for cross-charge treatment of AP invoices by the multi-entity processing system, which is associated with autonomous preparation of inter-entity electronic documents.

FIG. 7 illustrates a high-level architecture of the multi-entity processing system which is associated with autonomous preparation of inter-entity electronic documents.

FIG. 8 shows a functional data model for the multi-entity processing system which is associated with autonomous preparation of inter-entity electronic documents.

FIG. 9 illustrates an embodiment of a computing system configured with the example systems and/or methods disclosed.

### DETAILED DESCRIPTION

In one embodiment, systems, methods, and other embodiments are presented herein that provide an adaptive framework for multi-entity detection, data sourcing, and processing. The adaptive framework may be implemented as, for example, a multi-entity processing engine. The multi-entity processing engine may be used, for example, for intercompany document preparation. In one embodiment, the multi-entity processing engine is configured to detect that a document ingested for a process concerns more than one entity, and in response, to branch the document processing flow to initiate inter-entity (e.g., inter-company) document processing between the entities. In one embodiment, this inter-entity branch processing flow locates or creates data for downstream inter-entity operations as needed, and then automatically performs the inter-entity operations. The branch flow for inter-entity document processing may operate asynchronously to avoid delaying processing for the first entity, while maintaining idempotent processing of the data in both the original and branch pipeline.

In one embodiment, the multi-entity processing engine may be configured to provide a centralized platform for autonomously creating and routing intercompany transaction documents regardless of originating source or transaction type. For example, the multi-entity processing engine may be configured to orchestrate multiparty intercompany transactions initiated from one or more source systems, including accounts payable, accounts receivable, cash management, other internal enterprise modules, and external applications. The multi-entity processing engine ingests documents from heterogenous source systems, detects from the ingested documents a transaction between multiple parties under common control, pre-builds context used to complete processing of the transaction, and orchestrates the execution of those steps through downstream automation.

The multi-entity processing system provides an open integration platform for automating multi-party transaction processing directly from diverse source documents. The system is designed to accept input from various formats and systems (e.g., internal and external applications, spreadsheets, and manual entry), detect multiple parties in a transaction, and intelligently normalize and route the data to generate intercompany transactions in each party's system of records. Thus, in one embodiment, the multi-entity processing system replaces custom, point-to-point integration between entities with an open ingestion layer that can handle multiple data formats and sources. In one embodiment, the multi-entity processing solves the problem of data duplication by introducing idempotency controls into inter-entity transaction processing. In one embodiment, the multi-entity processing system accommodates partial data and prevents premature processing with logic for deferred execution. And, in one embodiment, the multi-entity processing system replaces tightly-coupled workflows with event-driven microservices, enhancing modularity and fault isolation. The multi-entity processing system thus introduces a variety of previously unavailable technical improvements in data ingestion and processing.

Thus, in one embodiment, the multi-entity processing system is not limited in application to intercompany scenarios, but is widely applicable across a variety of domains where workflows of more than one entity is implicated when processing an individual document, as discussed in further detail herein. For example, the multi-entity processing system may be applicable to other domains including healthcare data exchange, supply chain coordination, telecommunications provisioning, cloud resource federation, government inter-agency processing, insurance claim handling, and digital media licensing, thereby providing a generalized framework for adapting single-entity processing of a data object with workflows for multiple entities associated with the data object.

### Definitions

As used herein, the terms “inter-entity” and “inter-company” refer to activities, relationships, or transactions conducted between two or more entities that are under common control.

Various initialisms, acronyms, and abbreviations may be used herein, including: Accounts Payable (AP), Accounts Receivable (AR), API (Application Programming Interface), Advanced Global Intercompany System (AGIS), Cash Management (CM), Document Preparation (DP), Enterprise Resource Planning (ERP), Functional Design (FD), General Ledger (GL), Intercompany (IC), Legal Entity (LE), Lists of values (LOV), Payment on Behalf of (POB), Transfer Authorizations (TA), transaction (trx), and user interface (UI).

No action or function described or claimed herein is performed by the human mind. An interpretation that any action or function can be performed in the human mind is inconsistent with and contrary to this disclosure.

### Example Multi-Entity Processing System

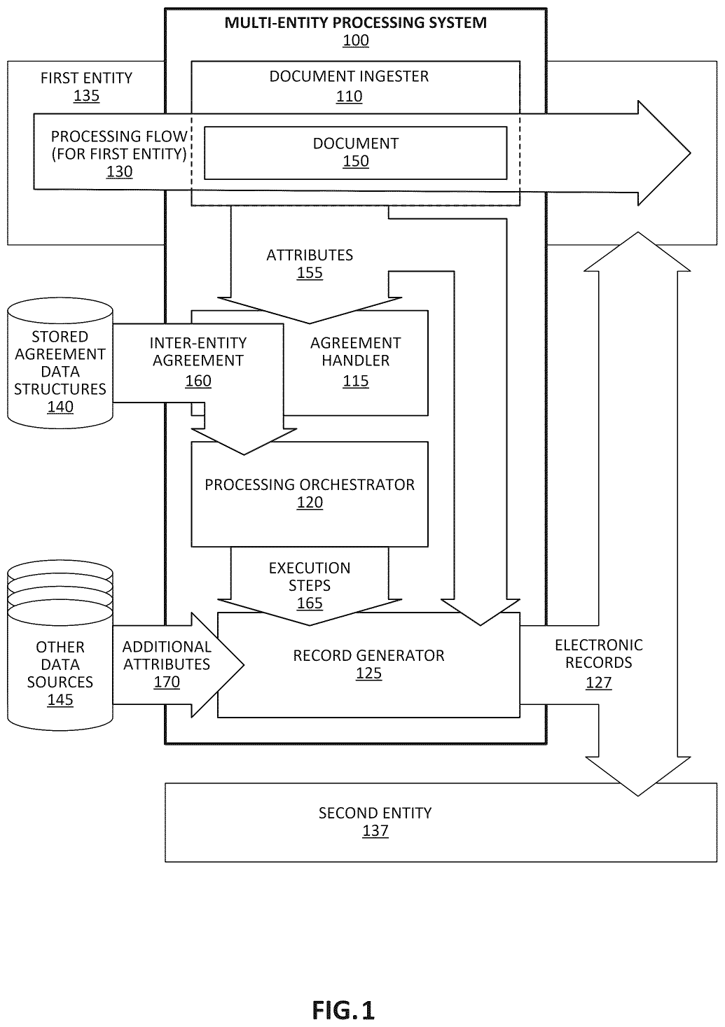

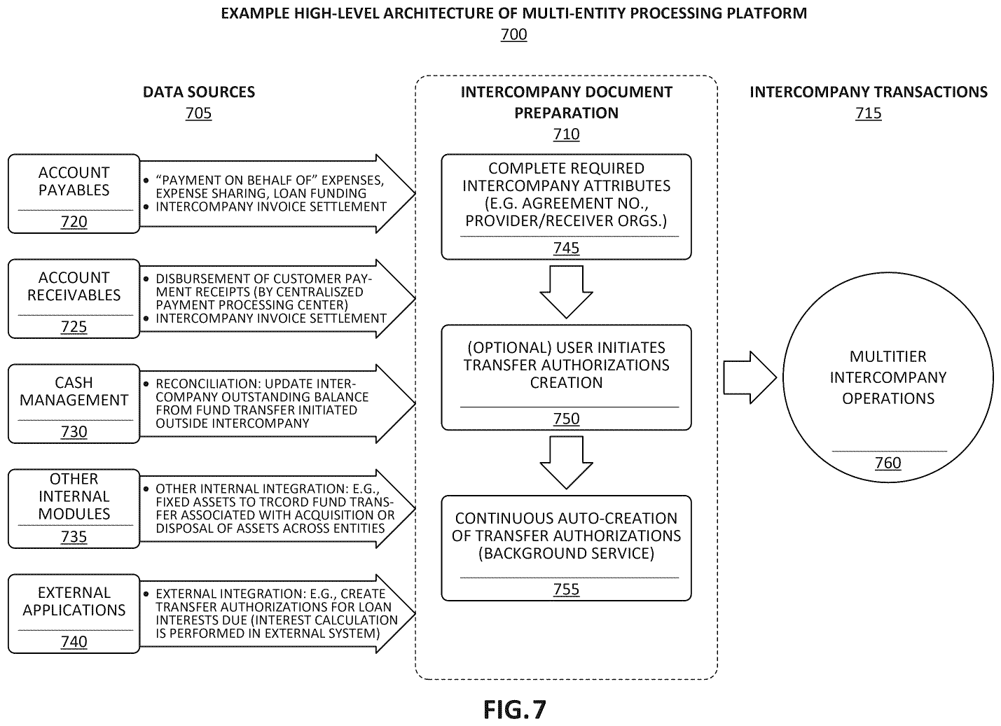

FIG. 1 illustrates one embodiment of a multi-entity processing system 100 that is associated with autonomous preparation of inter-entity electronic documents. In one embodiment, multi-entity processing system 100 automatically identifies, orchestrates, and completes inter-entity process executions by extracting relevant information from source documents and coordinating processing steps across entities to generate electronic records 127 of the execution. In one embodiment, multi-entity processing system 100 has various components, including a document ingester 110, an agreement handler 115, a processing orchestrator 120, and a record generator 125. Multi-entity processing system 100 may monitor processing flows for one or more entities, such as processing flow 130 for first entity 135. Multi-entity processing system 100 may access and retrieve information from a data store containing stored agreement data structures 140 that describe processing between entities. Multi-entity processing system 100 may access and retrieve information from one or more other data sources 145, such as account payables 720, account receivables 725, cash management 730, other internal modules 735 that are internal to the entities, and external applications 740 (as shown in and described with reference to FIG. 7). In one embodiment, the components of multi-entity processing system 100, first entity 135, second entity 137, other entities, stored agreement data structures 140, and other data sources 145, intercommunicate in a network computing system, for example by electronic messages, as discussed below under the heading “Cloud or Enterprise Embodiments.” The components of multi-entity processing system 100 are configured to make information that they generate available as output for downstream processing by one or more other components of multi-entity processing system 100.

In one embodiment, document ingester 110 is configured to parse data of a document 150 being processed in a processing flow 130 for a first entity 135 to extract attributes 155 of the document 150 and detect that the document 130 also concerns a second entity 137 based on the attributes 155. In one embodiment, agreement handler 115 is configured to determine, in response to the detection, an inter-entity agreement 160 that governs processing between the first entity 135 and the second entity 137 by matching one or more of the attributes 155 of the document 150 against stored agreement data structures 140. In one embodiment, processing orchestrator 120 is configured to automatically orchestrate processing of an inter-company transaction between the first entity 135 and the second entity 137 by generating execution steps 165 according to sequential and parallel dependencies specified by the inter-entity agreement 160. In one embodiment, record generator 125 is configured to generate, based on the attributes 155 and additional attributes 170 from other data sources, electronic records 127 in a system of the first entity 135 and a system of the second entity 137 that reflect execution of the inter-company transaction.

In one embodiment, each of the components described above—including the document ingester 110, agreement handler 115, processing orchestrator 120, and record generator 125—may be implemented as one or more software modules executing within a computing environment or as one or more autonomous agents operating with independent process lifecycles. When implemented as modules, the components may be packaged as services, libraries, or microservices that expose defined interfaces for inter-component communication. In one embodiment, the architecture includes microservices, each handling a specific task, such as transfer authorization creation. When implemented as autonomous agents, the components may maintain internal state, operate asynchronously, and coordinate through message passing, event triggers, or shared data stores to accomplish multi-entity processing tasks. This modular, agent-based, or microservice-based architecture enables flexible deployment of the multi-entity processing system 100, allowing the components to scale independently, be upgraded without disrupting other components, and integrate into different enterprise or cloud computing environments.

In one embodiment, the multi-entity processing system 100 uses a microservices-based architecture from data ingestion by document ingester 110 all the way through to creation of an intercompany transaction (or other electronic record 127) by record generator 125. The components of multi-entity processing system 100 may therefore individually be made up of one or more interoperating microservices.

In one embodiment, transactions are stored (e.g., in systems of record for first entity 135 and second entity 137) along with structured control attributes. In one embodiment, communication by multi-entity processing system 100 occurs over REST APIs.

In one embodiment, the multi-entity processing system 100 is configured to ingest, evaluate, and process intercompany documents (e.g., document 150) across multiple heterogeneous sources (such as first entity 135 and other data sources 145). The multi-entity processing system 100 accepts input (e.g., of document 150 or of documents that include additional attributes 170) from a variety of formats and channels, including spreadsheets, application programming interfaces (APIs), and manual entry through a user-interface to multi-entity processing system 100. Each transaction document (e.g., document 150) ingested into the system is automatically enriched with metadata tagging by document ingester 110, which provides routing information to help determine the applicable inter-entity agreement 160 and associated processing flow. For example, metadata may indicate whether the transaction should follow a cross-charge flow, a settlement tracking flow, or another intercompany processing path, each of which may be governed by a different inter-entity agreement, or distinct section of the inter-entity agreement. The use of metadata tagging ensures that transactions are routed consistently across different modules and enables machine-readable control of downstream processing.

In one embodiment, the multi-entity processing system 100 incorporates a readiness queue (also referred to herein as a deferred processing queue) associated with record generator 125. The readiness queue holds transactions that are not yet complete due to missing attributes. The readiness queue maintains transactions in a deferred state until all required data attributes are available, such as assignment of an intercompany agreement identifier or identification of a beneficiary entity. The readiness queue is continuously monitored by a readiness evaluator service that applies completeness checks based on metadata flags and readiness indicators. This use of the readiness queue prevents incomplete transactions from propagating into downstream modules, reduces retries, and improves processing efficiency.

In one embodiment, the processing services of the multi-entity processing system 100 are exposed through REST APIs. These services allow external and internal modules to submit transactions (e.g., document 150), retrieve status, or supplement missing data attributes (e.g., by submitting additional attributes 170). The processing services also integrate with pattern-based assignment logic for required fields. For example, the system may automatically assign an agreement identifier by detecting attribute patterns in the document and comparing them against historical transactions and agreements, or by applying trained machine learning models.

In one embodiment, individual transactions processed into the multi-entity processing system 100 for document preparation correspond to a database record stored within a structured data model. The database record maintains a set of key attributes that ensure traceability and support downstream processing. Attributes of each record may include: a Source_application_id identifying the originating module or application; a Doc_reference_id serving as a composite key to uniquely identify the document and its related distribution lines; a Processing_flow value identifying the processing path; an Agreement_id that links the transaction to a governing intercompany agreement; a TransferAuthorization_id that links the record to an authorization for intercompany transfer; and additional attributes from the source document, such as document date, amount, currency, and legal entity identifier. These attributes provide both contextual information and the control values required for automated processing.

In one embodiment, the multi-entity processing system 100 includes multiple system modules that interact to carry out the processing of intercompany documents. In one embodiment, an ingestion service (e.g., document ingester 110) validates incoming transactions, enforces idempotency, and records source data into the document preparation database. For example, document ingester 110 may assign a unique idempotency key to each transaction and reconcile duplicate submissions or partial writes, ensuring a single canonical record outcome.

In one embodiment, a document preparation module (such as record generator 125) is configured to assign attributes (e.g., attributes 155, additional attributes 170) that are used to complete processing, such as agreement identifiers or beneficiary organizations. These assignments may be made through REST API calls from other systems (e.g., other data sources 145), automatically using pattern-based logic or inference models, or occasionally by receiving user input through a user interface. This flexibility allows the multi-entity processing system 100 to complete transactions using multiple data sources without disrupting originating processes (such as processing flow 130).

In one embodiment, record generator 125 includes a readiness evaluator and a readiness queue. Record generator places transactions which do not yet have all attributes needed to complete the generation of the electronic records 127 for the transaction into the readiness queue to await availability of the missing attributes. The readiness evaluator continuously checks whether each transaction in the readiness queue has all required fields to proceed with intercompany processing. If a required field is missing, the evaluator retains the transaction in the readiness queue until the field is supplied by user input, retrieved from an integrated system, or inferred by a machine learning model.

Once a transaction is complete, record generator 125 creates intercompany transfer authorizations and related intercompany documents—electronic records 127 that describe the transaction. These generated documents reflect the governing agreement, the transfer authorization details, and supporting accounting attributes. Record generator 125 may include a transfer to general ledger (GL) module configured to generate GL journals from the authorized intercompany transactions and import them into the GL system of record for authoritative posting. For settlement operations, record generator 125 may include a settlement orchestrator configured to determine the netted intercompany position across entities, retrieve real-time bank balance data, and initiate intercompany cash movement by transmitting settlement instructions to a cash management system. In one embodiment, record generator 125 may include a settlement recorder module that is configured to accept settlement information returned from the cash management system, record the settlement, and adjust balances to maintain accurate intercompany receivables and payables.

These modules work together to ensure that transactions are accurately ingested, prepared, validated, generated, and settled in a consistent and automated manner, reducing manual reconciliation and increasing processing reliability across distributed enterprise systems.

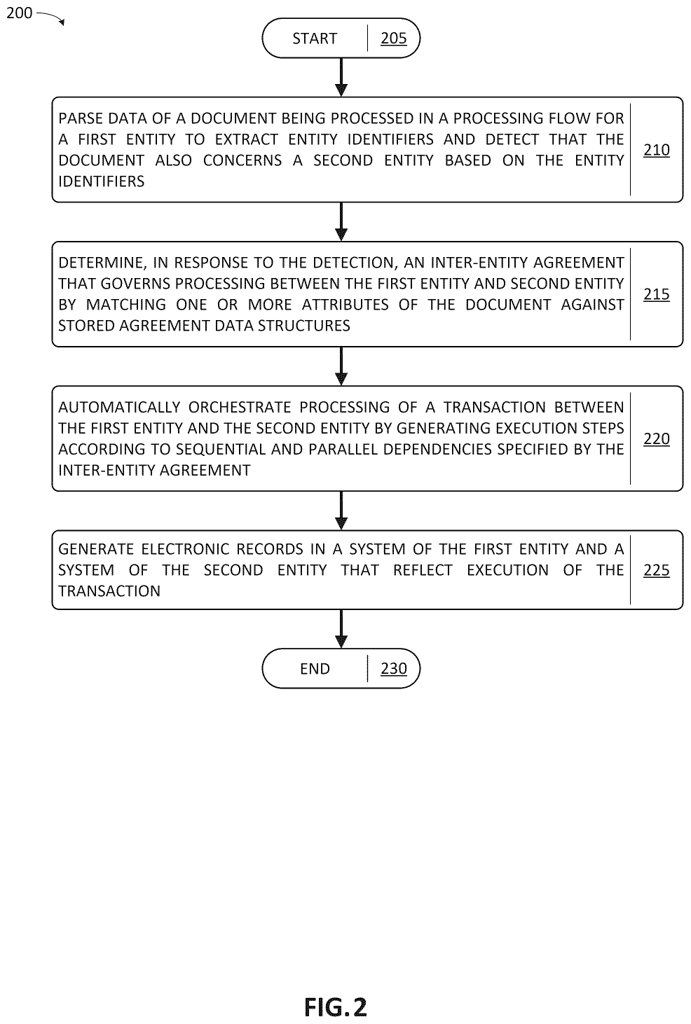

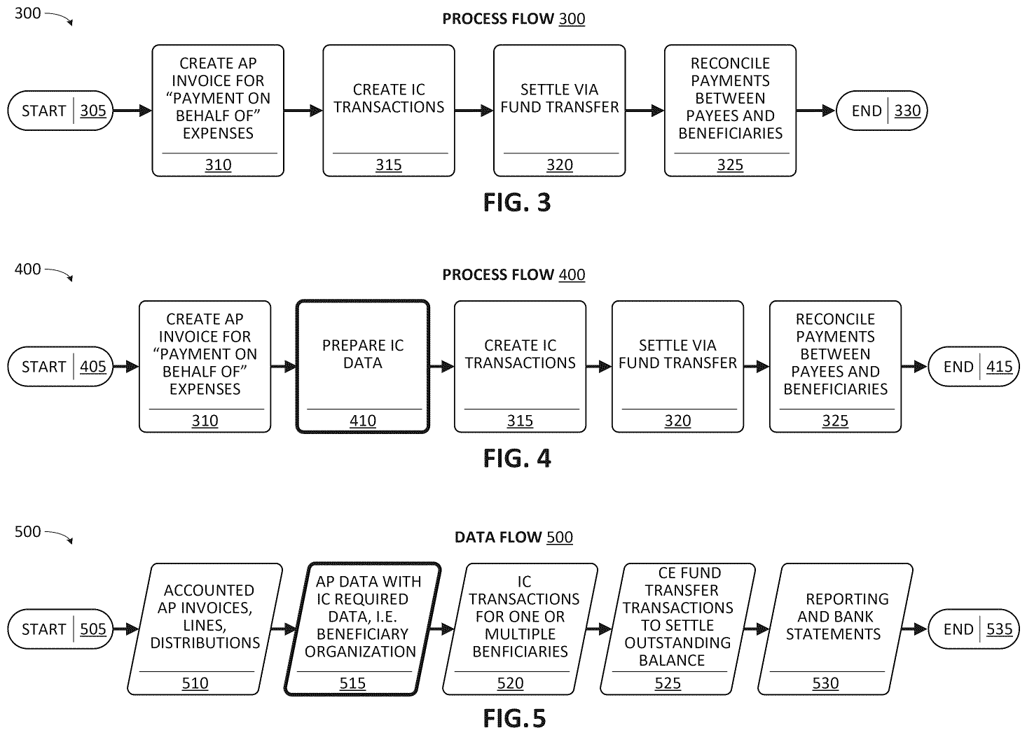

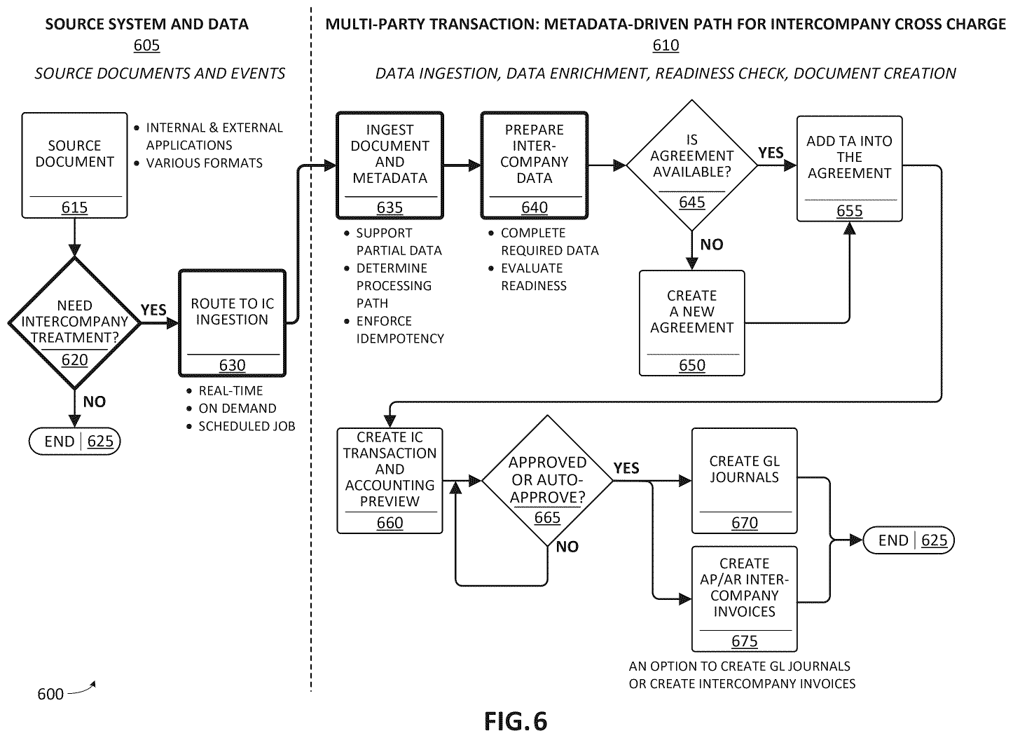

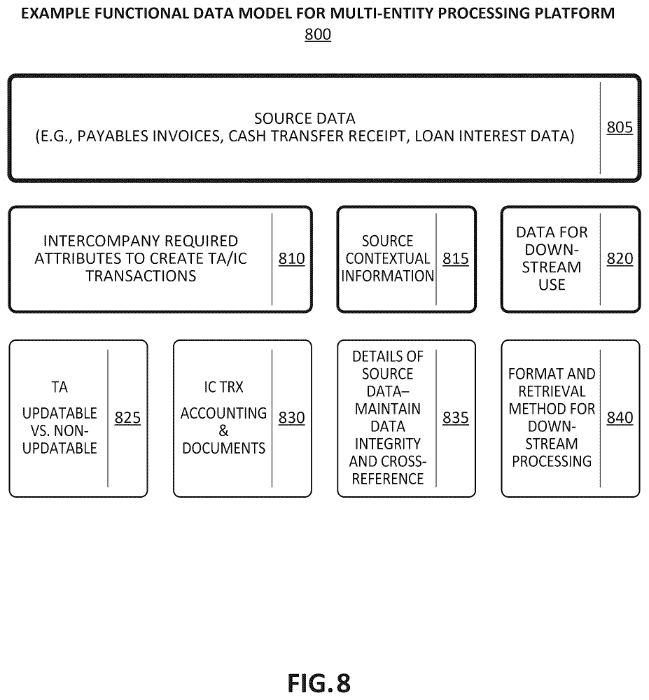

Further details regarding multi-entity processing system 100 are presented herein. In one embodiment, operations of multi-entity processing system 100 will be described with reference to multi-entity processing method 200 of FIG. 2. In one embodiment, an example of an unimproved process flow for an inter-entity transaction (e.g., payment reconciliation) will be described with reference to process flow 300 of FIG. 3. In one embodiment, operation of the multi-entity processing system 100 to prepare intercompany data as part of an improved process for inter-entity transaction will be described with reference to process flow 400 of FIG. 4. In one embodiment, data flow for the multi-entity processing system 100 to prepare intercompany data as part of an improved process for inter-entity transaction will be described with reference to data flow 500 of FIG. 5. In one embodiment, more detailed operation of multi-entity processing system 100 will be described with reference to process flow 600 of FIG. 6. In one embodiment, a high-level architecture of the multi-entity processing system 100 will be described with reference to architecture diagram 700 of FIG. 7. In one embodiment, data used by multi-entity processing system 100 will be described with reference to functional data model 800 of FIG. 8.

### Example Multi-Entity Processing Method

FIG. 2 illustrates one embodiment of a multi-entity processing method 200 that is associated with autonomous preparation of inter-entity electronic documents. In one embodiment, as a general overview, multi-entity processing method 200 operates to automatically detect when a document involves multiple entities, apply the governing agreement, orchestrate the transaction steps, and generate synchronized records in systems of the multiple entities.

Initially, multi-entity processing method 200 parses the document: the multi-entity processing system reads the document in a workflow for the first entity, pulls out key fields (attributes), and recognizes that the document also involves a second entity. Then, multi-entity processing method 200 locates the governing agreement: using the attributes parsed from the document, the multi-entity processing system looks up and selects the inter-entity agreement that applies to processing the document for the two entities from among other agreements in stored data. Multi-entity processing method 200 then orchestrates execution of a transaction to fulfill obligations from the document: the multi-entity processing system creates an ordered plan of tasks (some in sequence, some in parallel) to carry out the inter-company transaction as defined by the agreement. And, multi-entity processing method 200 generates documentation that gives effect to the transaction: Using the extracted attributes plus any needed data from other systems, the system creates complementary transaction records in systems of both entities to show that the inter-company transaction was executed.

In one embodiment, multi-entity processing method 200 initiates at START block 205 in response to multi-entity processing system 100 determining that one or more conditions or events have been detected or have occurred. The conditions or events for initiating multi-entity processing method 200, include, but are not limited to: (1) multi-entity processing system 100 has received an instruction to generate inter-entity transaction records for a document that relates to multiple entities; (2) multi-entity processing system 100 detects an ingestion event-a new document is received into a processing flow for the first entity that is monitored by the multi-entity processing system; (3) a user or administrator has initiated multi-entity processing method 200, for example through a graphical user interface or API call; (4) the multi-entity processing system reaches a time or interval at which multi-entity processing method 200 is scheduled to be run; (5) a connected application transmits a message or API call indicating that a transaction is to undergo the multi-entity processing method 200; (6) one or more stored agreement data structures are updated, potentially necessitating reevaluation under multi-entity processing method 200 of documents currently in processing queues; (7) a deferred document in a readiness queue becomes complete or inferable, enabling multi-entity processing method 200 to begin; (8) multi-entity processing system 100 identifies a failed or partial transaction and, for error recovery, re-initiates processing under an idempotency key to ensure consistent completion; or (9) some other condition for commencing multi-entity processing method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of multi-entity processing system 100 executes multi-entity processing method 200. In one embodiment, at START block 205, multi-entity processing system 100 configures compute resources for performing multi-entity processing method 200. (1) multi-entity processing system 100 provisions (i.e., allocates and initializes) resources of the computing system that are used by multi-entity processing system 100, such as processor, memory and storage (for example, for executing components of multi-entity processing system 100). (2) multi-entity processing system 100 establishes access to one or more networks for the resources, such as access to (a) internal networks for communication among components of multi-entity processing system 100 and (b) external networks for communication with other computing systems (for example, client systems or systems of the first entity 135 or second entity 137). (3) multi-entity processing system 100 connects to data sources such as systems of the first entity 135 and second entity 137, stored agreement data structure 140, other data sources 145 (e.g., databases, data stores, file systems, and cloud storage) used by the multi-entity processing method 200. And, (4) multi-entity processing system 100 configures the computing system with system settings, software dependencies and libraries, and modules for executing the components of multi-entity processing system 100. Following initiation at START block 205, multi-entity processing method 200 proceeds to block 210.

### Example Multi-Entity Processing Method-Document Ingestion

At block 210, multi-entity processing method 200 parses data of a document being processed in a processing flow for a first entity to extract attributes of the document and detect that the document also concerns a second entity based on the attributes. In one embodiment, the multi-entity processing method 200 parses data of a document in a processing flow, extracts attributes, and detects involvement of a second entity. For example, the multi-entity processing method 200 reads a document in a workflow, pulls out key fields, and from the key fields recognizes that another entity is also involved.

The multi-entity processing method 200 analyzes structured or semi-structured document data in a workflow, extracts attributes of data and/or metadata, and identifies multi-entity participation. The method extracts attributes from the document, where attributes include machine-readable identifiers such as entity codes, ledger IDs, account codes, or metadata fields. The method applies comparison logic to detect that one or more extracted attributes correspond to a second entity. The method parses document data using automated extraction logic to identify attributes that reference entity identifiers. The method then evaluates those identifiers against known references to detect participation of a second entity. Detection occurs when the system confirms that entity identifiers in the document associate the document with multiple distinct entities.

In one embodiment, a processing flow is a defined sequence of computer-executed operations applied to a document or transaction, which is configured by machine-readable control attributes such as processing status codes, workflow identifiers, event triggers, and data dependencies.

In one embodiment, an entity is a computing construct representing a distinct legal or organizational unit in a computing system, distinguishable from other entities during automated processing by machine-readable attributes such as a legal entity identifier, business unit identifier, ledger association, or account code combination.

In one embodiment, multi-entity processing method 200 parses data of a document being processed in a processing flow for a first entity to extract attributes of the document and detect that the document also concerns a second entity based on the attributes as follows. The system retrieves the document payload from the processing flow memory space. The system applies a parser to extract attributes such as entity IDs, ledger codes, or account numbers. The system loads entity reference data from stored configurations or data sources. The system compares extracted attributes to entity reference data to identify matches. The system sets a detection flag when a match indicates the document concerns more than one entity.

Note that, in one embodiment, the multi-entity processing system is not limited to handling documents (or other data objects) that implicate only two entities. Rather, the system is configured to detect and process documents that involve multiple entities, including second, third, fourth, or further additional parties beyond the originating entity. For example, a business document such as a payable-on-behalf-of (POB) invoice may identify one or more beneficiary entities in addition to the paying entity. The system automatically generates the corresponding intercompany transaction or transactions for each detected beneficiary entity, with each transaction aligned to the applicable inter-entity agreement and recorded in the system of record of the relevant entities. In this manner, the multi-entity processing framework supports one-to-many and many-to-many transaction flows without manual intervention.

Thus, in one embodiment, detecting that the document concerns a second entity further includes detecting that the document concerns one or more additional entities, and the subsequent blocks of method 200 may be performed for none, one or more, or each of the additional entities, depending on the configuration of the system.

In one embodiment, the steps of block 210 are performed by document ingester 110. At the conclusion of block 210, multi-entity processing method 200 has distinguished a document calling for inter-entity processing from single-entity documents. The steps of block 210 improve inter-entity document processing by normalizing heterogeneous document data into structured attributes that support early branching, enforce idempotent processing, reduce downstream reconciliation errors, and provide consistent input for orchestration and machine learning inference. By detecting multi-entity involvement at parse time, the multi-entity processing method 200 can branch processing flows early, preventing wasted compute cycles downstream. Attribute extraction standardizes heterogeneous document formats into a common structure, enabling consistent processing across multiple enterprise systems. Automatic detection of multi-entity attributes at ingestion prevents invalid single-entity assumptions, reducing reconciliation errors in downstream modules. Parsed attributes produce machine-readable identifiers that can be used to enforce idempotency keys and readiness checks, enabling safe retries. Entity detection based on machine-readable identifiers allows parallelized processing across large transaction volumes without manual classification. Extracted attributes are stored with lineage metadata, creating immutable evidence of how a document was classified for inter-entity processing. Parsing produces structured attributes that can be directly consumed by inference models, allowing intelligent completion of missing values. Processing continues to block 215.

### Example Multi-Entity Processing Method-Agreement Handling

At block 215, multi-entity processing method 200 determines, in response to the detection, an inter-entity agreement that governs processing between the first entity and second entity by matching one or more of the attributes of the document against stored agreement data structures. The multi-entity processing method 200 determines a governing inter-entity agreement by matching extracted document attributes to stored agreement data structures. The multi-entity processing method 200 finds the correct agreement between two entities by comparing document fields with agreement records stored in the system.

In one embodiment, the inter-entity agreement is a structured data object that encodes predefined rules for processing and/or other obligations between two entities, as well as associated dependencies for the processing. The inter-entity agreement may be, for example, a human-language (i.e., natural language) contract text that describes the processing rules, obligations, and/or dependencies. These agreements may be stored as data structures (e.g., stored agreement data structures 140) that contain information in a computer-readable storage format. The agreements may also be categorized with metadata attributes including, for example, entity codes or transaction types.

The multi-entity processing method 200 resolves the applicable contract or rule set by applying attribute-based matching between document attributes and the available agreements. The method uses attribute comparison logic to match document values against structured agreement data. The attribute comparison logic determines whether the extracted attributes and stored agreement fields satisfy a matching threshold condition that indicates a stored inter-company agreement to be associated with the document. A match that satisfies the threshold condition is thus identified as the specific inter-entity agreement that governs processing between the entities.

The attribute comparison logic may be, for example, deterministic matching logic, or for example, machine learning classification logic trained on prior (also referred to as historical) valid matches. In one embodiment, deterministic matching logic may be used initially to narrow the available inter-entity agreements down to a few candidates, and then the ML classification logic used to select one of the candidates. The attributes extracted from the document, and attributes of one of the inter-entity agreements may be passed as multivariate input to the ML classification logic to produce a match score. Or, in one embodiment, the attributes extracted from the document, and attributes of one of the inter-entity agreements may both be embedded into a shared vector space. The match score may then be determined by scoring similarity between the document attributes and agreement attributes in the vector space. The match score may therefore be (or be based on), for example, cosine similarity, Jaccard similarity, or Euclidean distance between the pair of embeddings.

In either case, the match score may be compared with match scores of other candidate inter-entity agreements, with the highest scoring agreement being selected as the matching agreement. In one embodiment, the highest scoring agreement may further be subject to satisfying a minimum threshold, for example a minimum match score of 80%, to be considered a match. Thus, the stored inter-company agreement that has the highest match score with respect to a document and that also satisfies the minimum match score threshold is determined to be associated with the document.

In one embodiment, multi-entity processing method 200 determines, in response to the detection, an inter-entity agreement that governs processing between the first entity and second entity by matching one or more of the attributes of the document against stored agreement data structures as follows. The system receives extracted attributes (from block 210). The system loads stored agreement data structures from a repository or database. The system applies a matching algorithm to compare attributes such as entity ID, currency code, or transaction type. The system filters candidate agreements based on matching conditions. The system outputs the agreement ID and metadata for the selected agreement.

In one embodiment, the steps of block 215 are performed by agreement handler 115. At the conclusion of block 215, multi-entity processing method 200 has identified, based at least in part on document attributes, which of a plurality of available inter-entity agreements governs processing. The multi-entity processing method thus automatically binds a document to the appropriate or “correct” rules for processing the document, ensuring accurate processing. The use of attribute-based matching ensures that agreement selection is precise, repeatable, and consistent from document to document. The steps of block 215 improve inter-entity document processing by enabling precise agreement selection through attribute-based matching with stored agreements. This reduces misclassification errors, allows consistent enforcement of entity-specific rules, and produces standardized references that downstream systems can process without custom mapping logic. The process is repeatable and machine-verifiable, avoiding ambiguity in agreement choice. Processing continues to block 220.

### Example Multi-Entity Processing Method-Processing Orchestration

At block 220, multi-entity processing method 200 automatically orchestrate processing of an inter-company transaction between the first entity and the second entity by generating execution steps according to sequential and parallel dependencies specified by the inter-entity agreement. In one embodiment, the multi-entity processing method 200 orchestrates an inter-company transaction by generating execution steps derived from sequential and parallel dependencies in the governing agreement. The method creates an ordered plan of tasks, based on the agreement, to carry out the inter-company transaction. A directed workflow of transaction tasks is generated by converting agreement rules into sequential and parallel process steps of a processing plan. The method builds the processing plan by analyzing dependency rules encoded in the inter-entity agreement. The processing plan specifies both sequential execution of dependent tasks and parallel execution of independent tasks.

In one embodiment, multi-entity processing method 200 generates a machine-readable execution plan by identifying execution steps and dependencies associated with the steps in the inter-entity agreement, and then automatically sequencing the execution steps in an executable order based on the dependencies. The execution steps are discrete process operations or tasks such as generating transfer authorizations or posting ledger entries. The execution steps are thus discrete tasks in the processing plan.

The dependencies may be sequential and/or parallel, specifying which tasks must precede others (sequential dependency) and which tasks can run concurrently (parallel dependency). Sequential dependency is thus a relationship between execution steps indicating that one step (such as obtaining a missing data attribute) is to be completed before another step can begin. Parallel dependency is thus a relationship between execution steps that allows steps to execute concurrently without conflict.

In one embodiment, the multi-entity processing system applies natural language processing (NLP) techniques to transform a human language inter-entity agreement into a directed acyclic graph (DAG) that defines an processing plan. The multi-entity processing system tokenizes agreement text into clauses and parses those clauses to identify action verbs, temporal markers, and logical connectors that describe obligations and task order. For example, the multi-entity processing system segment agreement text into tokens and dependency trees, and then applies semantic analysis to extract task descriptions, prerequisites, and concurrency indicators. The multi-entity processing system maps identified clauses to discrete execution steps, and converts temporal markers and logical connectors are converted into sequential and/or parallel dependency rules. For example, the system maps the clauses to structured data elements such as execution step identifiers, dependency types, and control flow markers.

In one embodiment, the dependency rules and tasks are assembled into a DAG data structure in which nodes represent execution steps and edges represent dependency relationships. For example, the multi-entity processing system applies graph construction logic that inserts nodes for each execution step and edges for each sequential or parallel dependency, with validation logic ensuring acyclicity of the resulting graph. The resulting DAG is a machine-readable processing plan data structure that encodes the agreement in a form suitable for automated execution by the record generator 125 or other processing orchestrator.

In one embodiment, this NLP-based conversion provides a technical improvement over prior systems by transforming unstructured legal or business language into structured control data that can be executed directly and autonomously by downstream processes. Prior approaches were error-prone and not adaptable to heterogeneous agreement formats. By producing a validated DAG from free-form agreement text, the system ensures consistent interpretation of agreements, prevents workflow deadlocks, and enables scalable orchestration across diverse transaction scenarios.

In one embodiment, the system validates the directed acyclic graph by traversing its nodes using a cycle detection algorithm, such as depth-first search with recursion tracking or topological sorting. If a cycle is detected, the system rejects or restructures the dependency rules to ensure the graph remains acyclic.

In one embodiment, multi-entity processing method 200 automatically orchestrates processing of an inter-company transaction between the first entity and the second entity by generating execution steps according to sequential and parallel dependencies specified by the inter-entity agreement as follows. The system extracts dependency rules from the inter-entity agreement, for example based at least in part on NLP analysis of the inter-entity agreement. The system maps each dependency rule to a discrete execution step. The system orders execution steps into a graph structure with sequential and parallel relationships. The system validates that the graph has no circular dependencies. The system outputs the graph as the processing plan for execution.

In one embodiment, the steps of block 220 are performed by processing orchestrator 120. Block 220 transforms dependency rules into a directed acyclic graph that encodes the order and concurrency of document processing tasks. At the conclusion of block 220, multi-entity processing method 200 has created a machine-readable processing plan for inter-entity document processing that can be validated, retried, and audited. The steps of block 220 improve inter-entity document processing by generating an encoding of task dependencies (e.g., as a DAG), enabling parallel execution of independent tasks, ensuring correctness of transaction sequencing, and preventing deadlocks or circular dependencies that could stall enterprise workflows. Processing continues to block 225.

### Example Multi-Entity Processing Method-Record Generation

At block 225, multi-entity processing method 200 generates, based on the attributes and additional attributes from other data sources, electronic records in a system of the first entity and a system of the second entity that reflect execution of the inter-company transaction. In one embodiment, the method generates synchronized electronic records in systems of both entities using document attributes and enriched attributes from connected sources. Matching or correlated transaction records may be created in the systems of both entities using extracted and/or inferred attribute fields, and additional attributes obtained from other systems. For example, the method may post electronic records into systems for the respective entities. The electronic records may be created by combining parsed document data and/or metadata with data from supplementary data feeds (e.g., other data sources 145) and/or further document data inferred from the parsed data/metadata.

Thus, in one embodiment, the method enriches extracted attributes with additional fields that are either (1) retrieved from internal or external data sources, or (2) inferred to complete missing attribute values by computer generation based on available data. The method then generates electronic records that are inserted into the respective systems of record for both entities, ensuring consistent representation of the executed transaction. A system of record may be, for example, a database or application module that serves as the authoritative source of truth for data, such as financial data or transactional data. In one embodiment, the electronic records are machine-readable entries in data systems that record an action or event, such as transaction entries in financial systems. Thus, the records reflect execution of an inter-entity action by encoding an action or event in the systems (e.g., ledger) of multiple entities.

In one embodiment, the multi-entity processing system reads the directed acyclic graph (DAG) that represents the processing plan and executes the transaction tasks in the order prescribed by the DAG. The multi-entity processing system executes tasks by traversing the DAG in the prescribed dependency order. The system identifies nodes of the DAG as discrete execution steps and evaluates the edges of the DAG to determine dependency relationships between those steps. The system initiates execution of steps that have no unmet dependencies, and upon completion of a step, updates dependency states of downstream steps. Parallel steps are initiated concurrently when dependency conditions permit, while sequential steps are initiated after prerequisite steps are confirmed as complete. Through this controlled traversal of the DAG, the system executes the tasks specified for the inter-company transaction, culminating in the creation of synchronized electronic records in the systems of the participating entities. This execution model ensures correctness of task sequencing, prevents deadlocks, and enables concurrent processing of independent steps, which improves efficiency and reliability of record creation across distributed systems.

In one embodiment, the multi-entity processing system infers missing attributes during DAG-based orchestration by applying a machine learning model(s) to generate likely values for missing attributes based on populated attributes. The machine learning model has been trained on historical transaction data and agreement records to approximate the actual values of attributes based on values of other attributes. Inputs to the model may include populated attributes from the document, contextual attributes from external data sources, and metadata describing inter-company transactions. The model produces as outputs candidate values for the missing attributes, together with associated confidence scores for the candidate values that quantify the likelihood that the candidate value is correct. The system may require a minimum confidence threshold, such as 0.80, before accepting an inference, with higher thresholds such as 0.95 applied for attributes that determine the identity, scope, or integrity of an inter-company transaction, such as entity identifiers or agreement references. (Alternatively, inference might not be permitted for such attributes.) Confidence scores below the defined threshold cause the system to move further processing of the document into a deferred processing queue to defer execution of the dependent DAG step until a sufficiently reliable attribute value is available.

In one embodiment, the system applies a failover sequence when attributes used for processing according to the DAG processing plan are unavailable. Where retrieval from connected data sources fails, the system may attempt inference if inference is permitted for the missing attribute. If the inference confidence score meets or exceeds the defined threshold, the inferred value is accepted and execution continues. If the score falls below the threshold, the dependent DAG step is enqueued in deferred processing queue for later reevaluation when additional data becomes available. Where inference is not permitted for one or more missing attributes, the system bypasses inference entirely and places the dependent DAG step directly into the delayed action queue. Examples of attributes for which inference might not be permitted include legal entity identifiers, agreement identifiers, and ledger identifiers, because the user may desire that these values should remain authoritative and verifiable to ensure data integrity across systems of record.

In one embodiment, multi-entity processing method 200 generates, based on the attributes and additional attributes from other data sources, electronic records in a system of the first entity and a system of the second entity that reflect execution of the inter-company transaction as follows. The multi-entity processing system retrieves extracted attributes (from block 210) and the processing plan (from block 220). The system queries additional data sources, such as accounts payable, accounts receivable, or cash management, to obtain missing attributes that are available from the additional sources. Where missing attributes are unavailable from the additional sources, the missing attributes may be inferred by applying rules, statistical models, or machine learning algorithms to one or more of those attributes that are available. The system formats a payload that includes an electronic record that describes an event or action payload, including for example identifiers, amounts, account codes, and agreement references. The system transmits the payload to the systems of record for the two entities using authenticated API or database writes to place synchronized electronic records of the action into the systems. The system may further log record creation events and store lineage metadata linking records to the originating document and agreement.

In one embodiment, the steps of block 225 are performed by record generator 125. At the conclusion of block 225, multi-entity processing method 200 has transformed enriched attribute data into synchronized electronic records and written the records into the authoritative systems of multiple entities. The creation of the synchronized records ensures that both entities maintain consistent state representations of the action or event, reducing reconciliation errors across multi-entity systems and enabling reliable end-to-end traceability of inter-entity processes. Advantageously, these steps reduce reconciliation overhead by ensuring consistent record creation in both systems contemporaneously. The resulting machine-verifiable record state can support downstream settlement, compliance, and audit functions. Processing continues to END block 230, where multi-entity processing method 200 concludes.

### Example Additional Features of Method-Missing Attribute Handling

In one embodiment, where attributes used for the processing of the inter-company transaction are missing, multi-entity processing method 200 further includes steps (performed, e.g., as part of the generation stage discussed at block 225) to acquire the missing attributes without wasting processing time or delaying processing of subsequent transactions. Multi-entity processing method 200 enqueues the document into a deferred processing queue (also referred to as a readiness queue) until the missing attributes are populated (or until information used by the process is complete, or inferable). As part of this “smart” ingestion and deferred completion, multi-entity processing method 200 collects one or more of the missing attributes from one or more other documents in other systems to further populate the attributes. And, multi-entity processing method 200 infers one or more of the remaining missing attributes based at least in part on the collected (and no longer missing) attributes using a machine learning model and/or pattern-based completion. Where the machine learning model is used, the system generates confidence scores for the inferences and compares them to pre-set thresholds to determine whether the inferred value is accepted.

In one embodiment, at block 235, the method addresses incomplete data required for inter-company transaction processing. The system evaluates attribute completeness using readiness status codes and completeness percentages stored with the document. Where one or more attributes are missing, the method enqueues the document into a deferred processing queue. The deferred processing queue is continually reevaluated as additional data arrives from connected systems, such as invoice records or prior transaction histories. Missing attributes may be collected by retrieving values from other documents in other systems that are integrated with the multi-entity processing system. Or, missing attributes may be inferred using a machine learning model trained on historical attribute correlations. The inference may be based on either or both of the attributes that were already present and the previously missing attributes that have been collected from other sources. The resulting output is either a document record with attributes completed and ready for processing or a document record with incomplete attributes that is queued for deferred processing until completion criteria are met.

In one embodiment, where attributes used for the processing of the inter-company transaction are missing, multi-entity processing method 200 further includes populating one or more missing attributes for the processing of the inter-company transaction by inference based on one or more of the already populated attributes. The system may perform partial ingestion and defer completion. The system may automatically populate expected attributes or fields that are missing based on inference based at least in part on populated attributes. The inference may be performed by machine learning prediction based on input of the one or more of the populated attributes. The inference may be performed by pattern-based prediction based on input of the one or more of the populated attributes.

In one embodiment, multi-entity processing method 200 infers missing attributes using populated attributes as input features. The inference may apply deterministic rules, such as mapping a liability-owning entity code to a corresponding beneficiary, or may invoke a machine learning prediction model. The prediction model evaluates attribute correlations learned from historical transactions to generate candidate values with associated confidence scores. The candidate values that satisfy a minimum threshold confidence (e.g., 80% or higher) for each attribute will be selected as the inferred value for the attribute. The system validates inferred attributes against stored agreement data structures to ensure consistency. The output result includes a set of populated attributes that may allow the inter-company transaction to proceed without user intervention.

### Example Additional Features of Method-Agreement Selection

In one embodiment, determination of the inter-entity agreement by multi-entity processing method 200 (for example as discussed above at block 215) further includes selecting the inter-entity agreement from among other agreements based at least in part on contents of the of the document and patterns derived from historical documents and agreements associated with the historical documents. For example the selection may be performed using deterministic matching logic, for example examining selection lists of agreement numbers (or agreement identifiers) for agreements that are active—valid and eligible for selection—and that are linked to or keyed by one or more entity attributes. And, for example the selection may be performed using a machine learning model trained to associate inter-entity agreements with documents based on patterns of association learned from of historical documents and historical agreements that correspond to the historical documents. Here, metadata such as an agreement identifier may be captured during ingestion and flagged for use in use in routing logic.

In one embodiment, at block 215, the multi-entity processing method 200 selects the governing inter-entity agreement using both direct content (the extracted attributes) of the document and learned historical patterns. The method retrieves candidate agreements that match high-level identifiers, such as entity codes, agreement status, or transaction currency. The method applies a machine learning model trained on past documents and their correctly associated agreements to classify a document as associated with a particular agreement. Input variables for the ML classification model may include one or more of the extracted attributes, including, but not limited to invoice line descriptions and supplier identifiers. The resulting output is a machine-selected agreement ID with a confidence score, which may override or confirm deterministic matching logic.

### Example Additional Features of Method—Graph-Based Plan

In one embodiment, automatic orchestration of processing of the inter-company transaction (for example as discussed above at block 220) by the multi-entity processing method 200 further includes generation of a directed acyclic graph (DAG) of the sequential and parallel tasks derived from the inter-entity agreement to represent orchestration logic. In this way, the processing plan is configured to represent sequential and parallel task dependencies.

In one embodiment, individual nodes in the DAG correspond to an execution step derived from agreement terms, such as generating transfer authorizations or posting accounting entries. Edges represent dependencies between steps, ensuring cyclic loops are not introduced. The DAG structure allows tasks that have no dependency relationship to be executed in parallel, improving processing efficiency. Once created, the processing plan exists as a DAG data structure stored in memory and ready for execution by downstream services (e.g., by record generator 125).

### Example Additional Features of Method-Automated Transaction

In one embodiment, generation of the electronic records (for example as discussed above at block 225) includes initiation of a settlement instruction by transmitting a bank transfer request to a cash management system. This serves to make the settlement process autonomous. The system may thus automatically settle outstanding intercompany balances by initiating a cash transfer, as discussed in further detail below.

In one embodiment, the multi-entity processing method 200 generates settlement instructions as part of record creation. The system formats a bank transfer request that includes transaction amount, beneficiary account identifiers, and agreement reference. The request is transmitted electronically to a connected cash management system via an authenticated API call or secure file transfer. The cash management system processes the bank transfer to settle the outstanding inter-company balance. In this case, the result is both (i) updated electronic records in the inter-company modules and (ii) an initiated settlement transfer in the cash management system.

### Example Additional Features of Method—Idempotent Processing

In one embodiment, multi-entity processing method 200 includes steps to enforce idempotent processing across multi-entity transaction flows. In one embodiment, the idempotency enforcement steps include: assigning an idempotency key to the document upon ingestion; reconciling duplicate submissions and partial writes associated with the idempotency key to a single canonical outcome; preventing duplicate creation of intercompany records in systems of the first entity and the second entity; and maintaining immutable lineage links between the document, the inter-entity agreement, intercompany transactions, and settlement records to ensure retries preserve a consistent end-to-end state.

As discussed below, in one embodiment, the use of flags and metadata enables documents to be independently processed for intercompany purposes without duplication in the process flow. The data model for multi-entity processing method maintains processing attempt counts and completeness indicators that support reconciliation of retries into a single consistent outcome. As discussed below, readiness evaluation logic routes only complete transactions downstream, which avoids duplicate record creation. Through these combined mechanisms, immutable lineage links are maintained between the document, the inter-entity agreement, related intercompany transactions, and settlement records, thereby ensuring consistent end-to-end state.

In one embodiment, multi-entity processing method 200 enforces idempotent processing across multi-entity transaction flows. Upon ingestion, the system assigns a unique idempotency key to the document, such as the document ID, and associates metadata flags that indicate whether a document is complete (i.e., has all attributes used to process the document), or not complete (i.e., has one or more missing attributes used to process the document). For example, this idempotency key may be the document ID itself. When retries or duplicate submissions occur, the system performs idempotency analysis using the idempotency key together with the metadata flags and processing attempt counts to reconcile partial writes and duplicates using the idempotency key to ensure a single canonical outcome. The system prevents duplicate creation of intercompany records in both the first and second entity systems by checking the key and the completeness status prior to record insertion. Immutable lineage links are maintained between the document, governing agreement, inter-company transaction, and settlement records, ensuring that retries always reproduce a consistent end-to-end state. his combined use of idempotency keys, completeness metadata, and reconciliation logic ensures uniform idempotent processing across distributed systems.

### Example of Multi-Entity Processing-Intercompany Invoice Preparation

In one embodiment, as an example of multi-entity processing, the multi-entity processing system performs an intercompany document preparation method. The intercompany document preparation method includes steps to automatically divert invoices for intercompany transactions (such as POB expenses) to a branch pipeline flow of intercompany transactions management software. The branch pipeline operates to automatically settle outstanding intercompany balances by cash transfer.

The method accesses an accounts payable invoice to a payee entity. The method detects from the data of the accounts payable invoice that the invoice also concerns a second beneficiary entity, for example as discussed above with reference to block 210. The method determines that there is an applicable intercompany agreement that governs processing between the payee entity and the beneficiary entity, for example as discussed above with reference to block 215. The method automatically transfers the invoice to intercompany document preparation in response to discovering the intercompany agreement. This may be a branch away from the process flow for accounts payable, allowing the accounts payable process to continue for the invoice, while initiating a parallel process for intercompany settlement. The method analyzes the intercompany agreement and determines that the invoice is payable by the payee entity on behalf of the beneficiary entity. The determination that the invoice is payable on behalf of the beneficiary entity may be determined from the applicable intercompany agreement, for example as discussed above with reference to block 220.

The intercompany document preparation method identifies information (attributes) about the beneficiary that the intercompany settlement process depends on, for example as discussed above with reference to block 220. The method then gathers or infers this information about the beneficiary from various sources and adds this information about the beneficiary to the invoice, for example as discussed above with reference to block 225. In the intercompany document preparation method, the method initiates an intercompany transaction between the payee entity and the beneficiary entity to re-charge the invoice to the beneficiary. To do so, the method is configured by an processing plan derived from the intercompany agreement to automatically create distinct complementary electronic records for the payee entity and the beneficiary entity.

For the payee entity, the method is configured by the processing plan to create: (a) an intercompany receivable record that represents the amount owed by the beneficiary entity; (b) a transfer authorization that establishes the right of the payee entity to recover the funds from the beneficiary entity; and (c) a journal entry in the payee system to recognize the receivable and ensure ledger balance. The transfer authorization approves movement of funds sufficient to pay the invoice from the beneficiary entity to the payee entity (thereby initiating settlement of the intercompany balance).

For the beneficiary entity, the method is configured by the processing plan to create: (a) an intercompany payable record that represents the obligation of the beneficiary entity to reimburse the payee entity; (b) a copy of the transfer authorization (or link to the transfer authorization referenced generated for the payee) that authorizes movement of funds to settle the obligation; and (c) a journal entry in the beneficiary system to recognize the payable and ensure ledger balance.

In one embodiment, placement of these records into these systems triggers the automatic transfer of funds from the beneficiary entity to the payee entity.

### Example System Architecture and Capabilities

In one embodiment, the multi-entity processing system automates flows from accounts payable (AP) to intercompany (IC). The system transfers AP data into IC using the entities' existing technology stacks, and employs an asynchronous model with idempotent processing to prevent redundant reprocessing. The system can receive partial transaction data and place it into a readiness queue until missing attributes are populated or inferred. The readiness queue continuously evaluates completeness, releases transactions when ready, and throttles execution to avoid overloading downstream systems. Metadata-based routing directs transactions to processing flows based on source, transaction type, and contextual attributes.

In one embodiment, the multi-entity processing system includes document preparation logic that parses source documents, extracts attributes, applies agreements, orchestrates dependent steps, and produces electronic records. This logic can be applied across multiple domains, making the system a platform technology for capturing documents from heterogeneous systems, normalizing attributes, and orchestrating ordered downstream steps.

In one embodiment, the system executes a document preparation phase that is operable across domains. The phase collects information from source systems, evaluates the information in the context of governing agreements, and orchestrates downstream steps automatically. Domains may include intercompany financial transactions, supply-chain coordination, multi-party contract administration, or healthcare information exchange. The orchestration may include determining sequential and parallel dependencies, initiating parallel processes, and enforcing prerequisite completion before dependent processes are triggered.

In one embodiment, the system performs partial ingestion of document data, allowing ingestion to occur before all attributes are available. Missing attributes may be added later by user input, by detection in subsequent documents, or by inference based on historical patterns or trained machine learning models. If data is incomplete, the transaction is placed in a deferred processing queue and reevaluated when new data arrives. This approach avoids blocking originating processes and ensures processing resumes once data is complete or inferable.

In one embodiment, the system performs intelligent ingestion by allowing partial ingestion, capturing metadata for orchestration, and completing missing data through deferred arrival or inference. This allows the system to operate on documents from diverse systems without imposing blocking requirements on external processes, improving over prior systems that delayed processing until all attributes were present.

In one embodiment, the system uses pattern-based matching to populate missing required fields by detecting patterns in attributes, comparing them to stored historical patterns, and inferring values such as beneficiary entity, agreement number, or account code combination.

In one embodiment, the system ingests source documents without altering or delaying the primary processes of those documents. For example, an AP invoice for paying an intercompany supplier may be flagged for intercompany processing without changes to invoice fields, allowing AP workflow to continue unimpeded while the system independently processes the invoice for IC settlement.

In one embodiment, source documents are identified for orchestration by a flag or metadata indicator added to the document record. A machine learning model may automatically apply the flag. Metadata captured with the flag may include an agreement identifier, process type code, or routing parameters.

In one embodiment, the system provides a centralized framework for ERP and other systems to interface data with minimal impact on integrating modules. The framework supports POB automation from AP and settlement recording from AR or CM. The system reduces manual reconciliation by allowing settlements from AR, AP, or CM to be recorded centrally, and enables data to be brought from external applications. Users may also view existing intercompany agreements and assign beneficiaries based on predefined agreements.

### POB Processing Example and Generalization

For example, the system automates recharging of payment-on-behalf-of (POB) expenses to beneficiary entities across countries. Without the system, such recharging requires custom software integrations. With the system, AP invoices labeled as POB are diverted to IC, agreements define the recharging steps, and automation recharges expenses across modules in a cohesive manner.

In one embodiment, the system includes steps to automatically prepare documents for intercompany cross-charge treatment of AP invoices. An invoice labeled as POB is diverted into IC document preparation. The system associates the invoice with an intercompany agreement, payee entity, and beneficiary entity, thereby creating an intercompany transaction document. The system then generates a transfer authorization document to settle the invoice between payee and beneficiary entities.

POB expenses are one example of costs paid by one entity on behalf of another. The system may also process intercompany transactions such as sale or purchase of goods, provision of services, licensing of intellectual property, intercompany loans and financing, cost-sharing arrangements, management fees, dividends, asset transfers, and cross-charges. Thus, the system provides a centralized platform for preparing, routing, and executing intercompany transactions regardless of origin or type.

POB expenses are payments made by a payee entity on behalf of a beneficiary entity, resulting in intercompany receivables for the payee and intercompany payables for the beneficiary.

The system automates the POB processing flow from AP invoices through IC transaction creation, balance tracking, and CM bank transfer for settlement. Without the system, users must perform these steps manually in AP, IC, and CM. Automation streamlines connectivity across these modules, improving efficiency and accuracy.

For example, a subscription charge of $1,000 incurred by a subsidiary is billed to a parent company. An AP invoice is created with the parent as payee and subsidiary as beneficiary. The parent pays the supplier, and the AP invoice is converted into IC transactions showing a $1,000 receivable for the parent and a $1,000 payable for the subsidiary. The subsidiary reimburses the parent per a predefined schedule, and users can view amounts paid and due.

### Example Processes and Data Architectures

FIG. 3 illustrates one example process flow 300 for cross-charge treatment of AP invoices without the multi-entity processing method. The process begins at start block 305 and proceeds to a first step 310, where an accounts payable (AP) invoice is created for “payment on behalf of” expenses. From step 310, processing continues to step 315, where intercompany (IC) transactions are created based on the AP invoice. At step 320, the IC transactions are settled by executing a fund transfer. Processing then advances to step 325, where payments between payee entities and beneficiary entities are reconciled. The process concludes at end block 330, representing completion of the reconciliation.

The multi-entity processing system is configured to provide at least the following two enhancements to inter-entity document processing: (1) integration from AP to IC for automatic creation of intercompany transactions, such as for POB expenses; and (2) integration from IC to CM for automatic settlement of intercompany balances by cash transfer.

For IC to CM integration, the system enables settlement of outstanding balances through bank transfer, with support for account-to-organization relationships, balance tracking, and built-in flows from IC to CM.

For AP to IC integration, the system enables direct conversion of AP invoices into IC transactions when expenses are paid by one entity on behalf of another. The system identifies POB invoices, assigns the beneficiary, captures invoice attributes, and generates agreements, transfer authorizations, and IC invoices. Automation supports real-time, on-demand, and scheduled flows.

The AP to IC flow includes: (1) creating AP invoices and identifying them as POB, with user interface support such as a checkbox; (2) initiating invoice transfer to IC, by scheduled job or on demand; (3) transferring invoice data to IC via API; (4) preparing IC data, including beneficiary assignment and initiation of IC transactions; and (5) creating IC transactions and transfer authorizations. Distribution lines associated with IC agreements, including taxes and charges, may be aggregated or split into multiple transfer authorizations.

The system can detect multiple parties in a single document and apply agreement-based logic to orchestrate sequential and parallel steps. For example, a three-party agreement may require settlements across provider, clearing entity, and beneficiary, with corresponding transfer authorizations and records generated in each system of record.

In one embodiment, IC receivables for the payee and IC payables for the beneficiary are automatically generated, and business users can cross-reference AP invoices and IC transactions.

AP to IC integration supports conversion of AP invoices to IC agreements and transfer authorizations, capture and display of IC attributes, cross-referencing between invoices and agreements, and automation in real-time, on-demand, or periodic jobs.

The system centralizes IC activities in the IC module, ensuring that beneficiary information and related IC data are captured in IC rather than AP.

FIG. 4 illustrates another example process flow 400 for cross-charge treatment of AP invoices that uses the multi-entity processing method to integrate information in advance of transaction document creation. Process flow 400 begins at start block 405 and continues to step 310, where an accounts payable (AP) invoice is created for “payment on behalf of” expenses. From step 310, processing advances to step 410, where intercompany (IC) data is prepared. Preparation of IC data at step 410 is performed by the multi-entity processing system to ready source document data and contextual attributes for downstream processing. From step 410, the process proceeds to step 315, where IC transactions are created based on the prepared data. Processing then continues at step 320, where settlement is performed via fund transfer. At step 325, payments between payee entities and beneficiary entities are reconciled. The process concludes at end block 415, where reconciliation is complete.

As shown, process flow 400 is similar to the process flow 300 of FIG. 3, but includes the additional step Prepare IC Data 410, which represents functionality performed by the multi-entity processing system to prepare document attributes and supporting data before creation of IC transactions. In one embodiment, inclusion of step 410 (Prepare IC Data) provides technical advantages over the process flow of FIG. 3 by introducing a discrete stage in which the multi-entity processing system ensures that only complete or inferable transactions proceed to downstream systems. Unlike the flow of FIG. 3, which advances directly from invoice creation to intercompany transaction creation, the flow of FIG. 4 incorporates step 410 to evaluate readiness using metadata flags that indicate whether attributes are complete or not complete, and to perform idempotency analysis to prevent duplicate handling. At this stage, the system may enrich transaction data by applying pattern-based matching or machine learning inference to populate missing attributes such as beneficiary assignment, agreement number, or account code combination, thereby improving data quality and reducing the need for correction. Step 410 also reduces downstream system load by holding incomplete transactions in a deferred queue and releasing them only when readiness criteria are satisfied, thereby preventing retries and errors in intercompany or cash management modules. In addition, the multi-entity processing system applies metadata-based routing at this stage to direct transactions into specialized flows, such as two-party or multiparty settlements, thereby increasing processing efficiency. By modularizing data preparation as a discrete step, the system achieves a domain-agnostic framework that supports finance, supply-chain, and other domains without redundant code, improving scalability and processing consistency.

FIG. 5 illustrates an example data flow 500 for cross-charge treatment of AP invoices that incorporates the multi-entity processing system. Example data flow 500 corresponds to the process flow 400 for intercompany cross-charge treatment of accounts payable (AP) invoices. Each stage transforms or augments the data for use in the subsequent stage. Example data flow 500 begins at start block 505 and proceeds to stage 510, where accounted AP invoices, invoice lines, and distribution data are provided. At stage 515, the AP data is supplemented with intercompany (IC) required data, such as identification of a beneficiary organization. Stage 515 serves to transform raw AP invoice data from stage 510 into AP data that is enriched with intercompany attributes so that the AP data is complete for purposes of generating intercompany transactions. Example data flow 500 then advances to stage 520, where IC transactions are created for one or multiple beneficiaries. Stage 515 enables reliable generation of IC transactions at stage 520 and subsequent settlement and reporting. At stage 525, clearing and execution (CE) fund transfer transactions are generated to settle outstanding balances associated with the IC transactions. Processing continues to stage 530, where reporting and bank statements are produced. The data flow concludes at end block 535, marking completion of the reporting stage.

Example data flow 500 illustrates the introduction by the multi-entity processing system of a structured transformation of source data before intercompany transaction creation. In particular, stage 515 (AP data with IC required data, i.e., beneficiary organization) is performed by the multi-entity processing system to prepare and normalize attributes required for downstream processing. At this stage, the system validates and completes intercompany attributes such as beneficiary assignment, applies readiness checks using metadata indicators, and may populate missing values through pattern-based inference or machine learning prediction. By performing these actions at stage 515, the multi-entity processing system prevents propagation of incomplete or inconsistent attributes into downstream systems and reduces retries and corrections. This separation of preparation from transaction creation provides improved data quality, reduced system errors, and greater efficiency in subsequent stages such as settlement and reporting. Unlike prior flows that move directly from AP invoice creation to IC transaction creation, the data flow of FIG. 5 demonstrates that performing a dedicated data preparation stage improves reliability, scalability, and processing efficiency for intercompany automation.

FIG. 6 illustrates a high-level solution flow 600 for cross-charge treatment of AP invoices by the multi-entity processing system, which is associated with autonomous preparation of inter-entity electronic documents. The solution flow 600 is divided into two sections, a source system and data section 605 and a multi-party transaction section 610. Solution flow 600 is a sequential and conditional flow in which source documents are ingested, metadata is evaluated, intercompany data is prepared, agreements are identified or created, and intercompany transactions are generated and either journaled or invoiced, with decision points controlling the path of execution.

In the source system and data section 605, a source document 615 is generated by internal or external applications and may be in various formats. At decision block 620, the multi-entity processing system evaluates whether the source document calls for intercompany treatment (for example as discussed above at blocks 210—detection of a second entity—and 215—selection of an applicable inter-entity agreement). If the document does not require such treatment, the solution flow 600 ends at end block 625. If the document does call for intercompany treatment, the multi-entity processing system routes the document to intercompany ingestion at block 630, which may occur in real-time, on demand, or by scheduled job.

In the multi-party transaction section 610, the multi-entity processing system proceeds to ingest the document and metadata at block 635. The ingestion supports partial data. The ingestion determines the appropriate processing path (for example as discussed above at block 220). And, the ingestion enforces idempotency. The multi-entity processing system then advances to prepare intercompany data at block 640. At block 640, multi-entity processing system completes data required for downstream and evaluates readiness of the data and current processing state for further downstream steps. At decision block 645, multi-entity processing system then determines whether a pre-existing agreement is available. If an agreement is available, the multi-entity processing system proceeds to add transfer authorization (TA) into the agreement 655. If no agreement is available, the process proceeds to create a new agreement 650, after which the transfer authorization is added to the agreement at block 655.

Processing then advances to create IC transaction and accounting preview at block 660, where multi-entity processing system generates intercompany transaction records and accounting entries for review. At decision block 665, multi-entity processing system determines whether the generated transaction is approved or auto-approved. If approved or auto-approved, multi-entity processing system proceeds to create general ledger (GL) journals 670 or create accounts payable/accounts receivable (AP/AR) intercompany invoices 675. If not approved, the system instead pauses to wait for approval. The process then concludes at end block 625, which may follow either journal creation or invoice creation.

Note, AP invoices for POB expenses may be created manually or in batch mode. IC transaction creation may occur immediately or on a scheduled basis.

FIG. 7 illustrates a high-level architecture 700 of the multi-entity processing system which is associated with autonomous preparation of inter-entity electronic documents. Architecture 700 is organized into three main modules: data sources 705, intercompany document preparation 710, and intercompany transactions 715. Architecture 700 is shown as a sequential and modular arrangement in which multiple data sources 705 feed into a centralized intercompany document preparation process 710, which in turn produces intercompany transactions 715 for use in multitier intercompany operations. Each of data sources 705 may be both (1) monitored for processing of documents that involve other entities in addition to the data source (and therefore potentially trigger a multi-entity processing process); and (2) serve as other data sources 145 for providing missing data for other multi-entity processing processes.

In the data sources section 705, multiple modules and systems may provide source data. An account payables module 720 provides data for functions such as payment on behalf of expenses, expense sharing, loan funding, and intercompany invoice settlement. An account receivables module 725 provides data relating to disbursement of customer payment receipts (e.g., by a centralized payment processing center) and intercompany invoice settlement. A cash management module 730 provides data for reconciliation, including updating intercompany outstanding balances from fund transfers initiated outside the intercompany process. An other internal modules block 735 provides data from additional internal systems, such as fixed asset modules used to record fund transfers associated with acquisition or disposal of assets across entities. An external applications block 740 provides data from external integrations, such as creation of transfer authorizations for loan interest payments where interest calculation is performed in an external system.

In the intercompany document preparation module 710, data from the various sources is processed to complete required intercompany attributes at block 745 (for example as shown and described above with reference to block 225), including agreement numbers and provider/receiver organization identifiers. By completing required attributes and converting transaction information into a uniform format before feeding the data into multitier intercompany operations, the multi-entity processing system improves data quality, reduces processing errors, and enhances scalability across domains and source systems.

At block 750, a user may optionally initiate creation of transfer authorizations. At block 755, transfer authorizations may also be generated automatically and continuously as a background service. The resulting data is then passed to the intercompany transactions section 715. At block 760, the intercompany transactions are applied within multitier intercompany operations.

The IC document preparation module 710 integrates source applications, prepares data, and enables automatic IC transaction creation. Users can review AP invoice data, assign beneficiary information, and initiate IC transactions through a graphical user interface. Distribution lines map one-to-one with IC transfer authorizations. The user interface can also display contextual attributes used for transaction creation, readiness status indicators, and data completeness percentages. The types of attributes that are used to create IC transactions or provide contextual source information are listed in Table 1 below.

TABLE 1

| | Attribute Description |
|---|---|
| 01 | Unique record/trx number in IC document preparation system |
| 02 | IC processing status, from not started to completed or error |
| 03 | Error message |
| 04 | Intercompany Accounting preview approval |
| 05 | Source application or module name |
| 06 | Source transaction type. |
| 07 | Source instruction to IC which is an action that can be |
| | performed for a TA. |
| 08 | Source first transaction identifier. Typically, this is |
| | a header level document number. |
| 09 | Source second transaction identifier. Typically, this is |
| | a line number within a document. |
| 10 | Source third transaction identifier. |
| 11 | Source fourth transaction identifier, reserved for |
| | future use. |
| 12 | Source transaction date |
| 13 | Source transaction description |
| 14 | Source transaction amount type such as Item, Tax, |
| | Freight, etc |
| 15 | Source transaction description |
| 16 | Source transaction supplier name |
| 17 | Source transaction supplier site |
| 18 | Source transaction customer name |
| 19 | Source transaction customer site |
| 20 | Source transaction organization type, such as Business |
| | Unit, Asset Book, etc |
| 21 | Source transaction organization name |
| 22 | Source transaction legal entity |
| 23 | Source transaction ledger |
| 24 | Intercompany agreement number |
| 25 | Intercompany provider organization |
| 26 | Intercompany clearing organization 1 |
| 27 | Intercompany clearing organization 2 |
| 28 | Intercompany receiver organization |
| 29 | Intercompany agreement description |
| 30 | Intercompany agreement transaction type |
| 31 | Intercompany agreement activation date |
| 32 | Intercompany agreement transaction currency |
| 33 | Intercompany transfer authorization reference number |
| 34 | Intercompany transfer authorization number |
| 35 | Intercompany transfer authorization description |
| 36 | Intercompany transfer authorization transaction date |
| 37 | Intercompany transfer authorization transaction amount |
| 38 | Intercompany transfer authorization transaction amount type |
| 39 | Intercompany related transfer authorization number |
| 40 | Intercompany transfer authorization currency conversion rate type |
| 41 | Intercompany transfer authorization currency conversion rate date |
| 42 | Intercompany transfer authorization settlement currency basis |
| 43 | Intercompany transfer authorization additional information (DFF) |
| 44 | Intercompany transfer authorization attachments |
| 45 | Intercompany transfer authorization status |

This integration enhances multitier intercompany operations, also referred to as agreement-based intercompany transactions, by automating creation of transfer authorizations, IC transactions, journals, and invoices.

FIG. 8 shows a functional data model 800 for the multi-entity processing system which is associated with autonomous preparation of inter-entity electronic documents. The data model 800 is organized to capture, maintain, and structure data used in intercompany processing. At the top of the model, source data 805 is received, which may include payables invoices, cash transfer receipts, loan interest data, or other transaction inputs. From the source data 805, multiple categories of information are derived or maintained.

Additional blocks capture related characteristics. Block 825 identifies whether transfer authorizations are updatable or non-updatable. Block 830 represents IC transaction accounting and documents generated from the source data. Block 835 captures details of the source data needed to maintain integrity and cross-reference, ensuring traceability between source inputs and intercompany records. Block 840 represents format and retrieval methods that enable downstream processing to access data in the required structure.

The automation of intercompany transactions from AP invoices covers IC solution components including organization definitions, APIs, data models, and user interfaces. In one embodiment, the IC document preparation data model includes a business object that stores source document information to prepare and create intercompany transactions. The columns of this business object, together with associated descriptions, are listed in Table 2 below.

TABLE 2

| | Column | Description |
|---|---|---|
| 01 | interco_ta_source_doc_id | Document preparation transaction |
| | | identifier. |
| 02 | interco_ta_source_number | Application generated unique |
| | | transaction number. |
| 03 | processing_status_code | Processing status of the intercompany |
| | | transaction. |
| 04 | error_message | Description for intercompany |
| | | transaction processing error. |
| 05 | approval_required_flag | Indicates whether the intercompany |
| | | transaction approval is required. |
| 06 | source_application_id | Identifies the associated source |
| | | application. |
| 07 | doc_action_code | Indicates whether the document is for |
| | | a reversal transaction. |
| 08 | doc_type_code | Type of source document such as |
| | | Invoice, Credit Memo, and Debit Memo. |
| 09 | doc_reference_id1 | First source document identifier. In |
| | | most cases, this is mapped to a |
| | | document header ID. |
| | . | . |
| | . | . |
| | . | . |
| 10 | doc_reference_id5 | Fifth source document identifier. |
| 11 | doc_number | Source document number such as invoice |
| | | number. |
| 12 | doc_line_number | Source document line number such as |
| | | invoice line number. |
| 13 | doc_distribution_number | Source document distribution number |
| | | such as invoice line distribution |
| | | number. |
| 14 | doc_addl_trx number1 | First additional source document number. |
| 15 | doc_addl_trx_number2 | Second additional source document |
| | | number. |
| 16 | doc_date | Document or transaction date such as |
| | | invoice date. |
| 17 | doc_description | Description for the source document. |
| 18 | doc_amount | Transaction amount for the source |
| | | document. |
| 19 | doc_le_id | Identifies the legal entity of the |
| | | source document. |
| 20 | doc_bu_id | Identifies the business unit of the |
| | | source document. |
| 21 | doc_asset_book_type_code | Identifies the asset book of the source |
| | | document. |
| 22 | doc_ledger_id | Identifies the ledger of the source |
| | | document. |
| 23 | doc_supplier_id | Identifies the supplier of the source |
| | | document. |
| 24 | doc_supplier_site_id | Identifies the supplier site of the |
| | | source document. |
| 25 | doc_customer_id | Identifies the customer of the source |
| | | document. |
| 26 | doc_cust_account_id | Identifies the customer account of the |
| | | source document. |
| 27 | doc_cust_bill_to_{—} | Identifies the customer bill to location |
| | location_id | of the source document. |
| 28 | doc_amount_type_code | Transaction amount type such as item, |
| | | tax, and freight. |
| 29 | doc_ccid | Account code combination of the source |
| | | document. |
| 30 | trx_provider_ccid | Provider account code combination of the |
| | | intercompany transaction. |
| 31 | agreement_id | Intercompany agreement identifier |
| | | associated to the source document. |
| 32 | source_doc_group_id | Unique identifier for intercompany source |
| | | document group. |
| 33 | source_document_id | Unique identifier for intercompany source |
| | | document. |
| 34 | ta_reference | Transfer authorization reference number. |
| 35 | ta_number | Transfer authorization number generated. |
| 36 | ta_description | Transfer authorization description. |
| 37 | ta_trx_date | Transaction date of the transfer |
| | | authorization. |
| 38 | ta_amount | Transaction amount of the transfer |
| | | authorization. |
| 39 | ta_amount_type_code | Transfer authorization amount type. |
| 40 | doc_currency_code | Transfer authorization currency. |
| 41 | reversed_doc_reference_id1 | First associated reversed source document |
| | | identifier. |
| | . | . |
| | . | . |
| | . | . |
| 42 | reversed_doc_reference_id5 | Fifth associated reversed source document |
| | | identifier. |
| 43 | attribute_category | Descriptive Flexfield: structure |
| | | definition of the user descriptive |
| | | flexfield. |
| 44 | attribute1 | Descriptive Flexfield: segment of the |
| | | user descriptive flexfield. |
| | . | . |
| | . | . |
| | . | . |
| 45 | Attribute15 | Descriptive Flexfield: segment of the |
| | | user descriptive flexfield. |
| 46 | attribute_number1 | Descriptive Flexfield: segment of the |
| | | user descriptive flexfield. |
| | . | . |
| | . | . |
| | . | . |
| 47 | attribute_number5 | Descriptive Flexfield: segment of the |
| | | user descriptive flexfield. |
| 48 | attribute_date1 | Descriptive Flexfield: segment of the |
| | | user descriptive flexfield. |
| | . | . |
| | . | . |
| | . | . |
| 49 | attribute_date5 | Descriptive Flexfield: segment of the |
| | | user descriptive flexfield. |
| 50 | created_by | Who column: indicates the user who |
| | | created the row. |
| 51 | creation_date | Who column: indicates the date and time |
| | | of the creation of the row. |
| 52 | last_updated_by | Who column: indicates the user who last |
| | | updated the row. |
| 53 | last_update_date | Who column: indicates the date and time |
| | | of the last update of the row. |
| 54 | last_update_login | Who column: indicates the session login |
| | | associated to the user who last updated |
| | | the row. |
| 55 | object_version_number | Used to implement optimistic locking. This |
| | | number is incremented each time the row is |
| | | updated. The number is compared at the |
| | | beginning and end of a transaction to |
| | | determine if another session has updated |
| | | the row since it was queried. |

In one embodiment, the data model further includes control attributes that track readiness status, completeness percentage, and processing attempt count for each transaction. The model can store inference confidence scores when missing attributes are populated using pattern-based matching or machine learning prediction.

### Example Functional Components

In one embodiment, the multi-entity processing system provides a framework to support an open platform concept that enables enterprise resource planning (ERP) systems and other applications to interface their data on a centralized basis. The framework is configured to permit such integration with minimal impact on the integrating modules, thereby avoiding extensive reconfiguration or disruption of existing workflows. The framework further enables integration with both internal modules of the enterprise system and external modules supplied by third-party applications, thereby broadening the scope of compatible data sources and destinations. For example, the multi-entity processing system supports payment-on-behalf-of (POB) automation from accounts payable (AP), as well as settlement recording originating from cash management (CM) or from both accounts receivable (AR) and accounts payable (AP). In addition, the multi-entity processing system is configured to enable integration with an agreement-based intercompany transactions management system, thereby providing consistent application of inter-entity agreements across all interfacing modules.

In one embodiment, the multi-entity processing system includes an application programming interface (API) to interface other processing systems (such as accounts payable (AP)) to intercompany (IC) document preparation. Using an AP system as an example, the API is invoked by AP to transfer invoice data into IC document preparation objects, where the AP invoice is flagged as payment-on-behalf-of (POB), accounted, and purchase order unmatched. The interfaced data may include either the initial distribution or the reversal distribution. A pre-specified collection of invoice data is interfaced from AP. The API transfers identifiers that uniquely identify an AP invoice, invoice line, and distribution line, although these identifiers are not displayed in IC document preparation. The API further transfers transaction data required for creation of intercompany transfer authorizations, and these attributes are displayed within IC document preparation. In addition, the API transfers transaction data that provides critical contextual information to support orchestration. Additional contextual information or invoice details may be accessible through a read-only invoice user interface.

More generally, the API is configured to transfer transaction data to the multi-entity processing system from multiple source modules, including but not limited to accounts payable, accounts receivable, cash management, other internal modules, or external applications, thereby enabling integration of heterogeneous source systems with IC document preparation (as shown in FIG. 7).

In one embodiment, the system transfers accounted POB invoice data to IC document preparation asynchronously.

### Example User Story

As an example, a subscription charge of $1,000, incurred by the Subsidiary Company A (aka beneficiary), is billed to the Parent Company. The Parent Company is liable to pay the supplier, and in turn recharge the expense to the Subsidiary Company A through intercompany transactions.

AP invoices for payment on behalf of expenses can be created manually via AP invoice UI or in batch mode. The creation of IC transactions is automated. The creation of the IC trx can be expected to complete immediately, or on a periodic basis such as daily, weekly, or monthly, or as otherwise scheduled. Resulting IC transactions: IC receivables of $1,000 for the Parent Company and IC payables of $1,000 for the Subsidiary Company A.

Note, the steps of the high-level solution flow 600 may be used to accomplish the user story above.

### Example User Experience: IC Document Preparation

Overview: IC Document Preparation enables users to review source data and prepare both required and optional supporting IC data so that the conversion of AP invoices to IC transactions can be automated. Data presentation: The data may be presented in a worksheet format to support excel like actions. This presentation style can be supported using various interface templates, such as a data grid template.

Intercompany Document Preparation: In one embodiment, users review the source data for IC transactions creation, and manually assign the beneficiary information as well as other supporting IC data. In one embodiment, the beneficiary information as well as other supporting IC data are automatically assigned based on the source data for IC transactions creation. For example, the new UI is titled Intercompany Document Preparation (DP). In one embodiment, the new UI is part of Multitier offering. Users access DP via Multitier root menu. Presentation layout: AP invoice distribution lines are presented as one row/record on the data grid. The default presentation layout is organized such that the source data is displayed first, then the IC related data is displayed after the source data. Display on the grid those of the IC attributes used to generate TA and IC trx. Other attributes can be viewed via a drawer or other UI element. User can hide/show columns, as well as freeze columns to keep context while scrolling. For the list of attributes, refer to Table 2 above. The user interface can display a readiness status indicator and a data completeness percentage for each transaction. Transactions awaiting additional data can be flagged, and the system can present suggested field values inferred through pattern-based matching, allowing the user to accept or reject each suggestion. The UI can also surface historical pattern matches for review before acceptance.

Agreement Number. In one embodiment, users manually assign a beneficiary to a POB transaction by selecting an agreement number from the Agreement lists of values (LOV). This agreement number will serve as a reference point, automatically populating the receiver organization (aka the beneficiary for the POB transaction). Business rules: LOV—List of active agreements with the following criteria: IC provider org is associated with the liability owning LE (invoice header attribute), Agreement status is Active. Agreement transaction currency is the same as invoice transaction currency.

### Example Improvements

Existing systems have documents in many formats that cannot be read consistently by computing systems. The heterogeneous document formats prevent uniform parsing. In one embodiment, the multi-entity processing system improves over the inability of existing systems to handle heterogenous document formats by converting all document formats into a single structured format that normalizes the document data into a uniform schema for storage of document attributes.

Existing systems do not detect multi-party involvement until late in processing, which wastes computing resources. The lack of early detection prevents branch flows from being initiated promptly. In one embodiment, the multi-entity processing system improves over the late detection problem by extracting entity attributes during parsing and triggering branch flows when a second entity is identified, thereby conserving processor cycles.

Existing systems create duplicate submissions that corrupt stored data across computing systems. The absence of idempotent processing causes retries and partial writes to produce conflicting records. In one embodiment, the multi-entity processing system improves over the lack of idempotent handling by assigning an idempotency key at ingestion and reconciling retries to a single canonical outcome.

Existing systems have workflows that deadlock because task order is not explicit. The absence of a machine-readable ordering structure causes circular dependencies in processing tasks. In one embodiment, the multi-entity processing system improves over deadlock-prone workflows by generating a directed acyclic graph that encodes dependency relationships and validates acyclicity before execution.

Existing systems execute tasks sequentially and fail to exploit modern multi-core processors. The absence of parallel task dispatch prevents independent steps from running concurrently. In one embodiment, the multi-entity processing system improves over sequential-only processing by dispatching DAG nodes without unmet dependencies in parallel, thereby increasing throughput on multi-core hardware.

Existing systems lack accurate, consistent matching between document attributes and stored agreements, which can produce conflicting results, leading to errors across connected systems. In one embodiment, the multi-entity processing system improves over inconsistent agreement selection by matching extracted, structured document attributes against structured agreement data to determine the correct governing agreement.

Existing systems do not consider reliability of machine learning outputs. The absence of confidence scores means inferred values can be stored even when inaccurate. In one embodiment, the multi-entity processing system improves over unreliable inferences by generating confidence scores for predicted attributes and applying thresholds before acceptance.

In existing systems, accessing data from external systems to prepare the document imposes blocking requirements on the external systems that stop operation of external processes until all data attributes for preparing the document are collected, causing substantial processing delays to the blocked systems. Existing systems may thus block entire workflows when input data is incomplete. Pipelines stall because no mechanism exists to defer and resume processing. In one embodiment, the multi-entity processing system improves over the susceptibility to blocked pipelines in existing systems by placing incomplete documents into a deferred processing queue and reevaluating readiness when data becomes available. In one embodiment, the multi-entity processing system continually evaluates documents that are in the deferred processing queue for completeness of data, enabling the processing to continue as soon as missing data becomes available. In one embodiment, the multi-entity processing is able to continually evaluate transaction readiness across thousands of documents in real time.

Existing systems may duplicate processing, which creates multiple records for the same transaction. The lack of lineage tracking causes retries to generate divergent outputs. In one embodiment, the multi-entity processing system improves over duplicate processing by maintaining lineage links between documents, agreements, and records to enforce a single canonical outcome.

Existing systems may duplicate processing, which creates multiple records for the same transaction. The lack of lineage tracking causes retries to generate divergent outputs. In one embodiment, the multi-entity processing system improves over inconsistency by generating synchronized datasets with shared identifiers and hashes.

Existing systems make unexplained decisions, and outputs cannot be traced. In one embodiment, the multi-entity processing system improves over opaque decisions by storing feature attributions and decision logs, enabling automated validation.

Existing systems lack idempotent processing logic and do not wait for data completion, thereby wasting processing cycles and generating unnecessary network traffic when processing redundant and/or incomplete submissions. In one embodiment, the multi-entity processing system improves over existing systems by reducing wasteful network traffic and processor cycles. For example, the multi-entity processing system incorporates idempotent processing logic to prevent redundant submissions from being re-processed, and it also employs deferred processing queues that intentionally delay processing until required data is completely available, thereby minimizing unnecessary data transmission and processing cycles.

Existing systems are unable to operate on partially ingested data, potentially delaying a primary processing of a document while awaiting data to perform a secondary processing. In one embodiment, the multi-entity processing system improves over existing systems by decoupling ingestion from processing, allowing source documents to be received and monitored independently from when they are processed. The design ensures that transactions are only processed when all required information is available, avoiding errors caused by missing data.

Conventional systems lack the ability to process intercompany transactions in real time from multiple source systems, particularly when transaction data arrives asynchronously or is incomplete. Existing processes are error-prone and cannot realistically evaluate thousands of transactions or maintain evolving pattern recognition over time. The disclosed system addresses these limitations by providing centralized ingestion, continuous readiness evaluation, automated completion of missing data, and idempotent duplicate prevention across all stages of intercompany transaction preparation and settlement.

In one embodiment, at a high level, multi-entity processing system (i) detects multi-party participation in a document; (ii) contextualizes process steps based on the document type and applicable agreements; (iii) automates progression and tracking of the process flow while maintaining integrity of process state; (iv) implements governance and traceability such that actions taken can be traced end-to-end and in reverse from originating document to final outcomes; and (v) produces downstream documents and transaction records in the system of record for each party to reflect execution of the orchestrated process.

For example, in the accounts payable space today, there is no direct flow of information from AP to intercompany settlement tools. Currently, for POB expenses, a custom integration or manual data entry is used to create intercompany transactions. An automation feature provided by the multi-entity processing system enables direct transfer of information from AP to the intercompany components and allows intercompany transactions to be created automatically upon creation of POB expenses in AP.

Today, there is no automation of intercompany settlement. A feature for AP POB invoices automation provided by multi-entity processing system enables automatic settlement through cash transfer that supports a timely and complete automation of POB settlement with full audit trail and accounting. Currently, the intercompany modules (or other logical components) of enterprise financial application suites (such as Fusion Intercompany) support the creation of AP/AR invoices, however, the settlement is done outside IC. Hence there is no visibility of outstanding balances in the intercompany components. The AP POB feature allows settlement to be done through CM bank transfer, and the initiation of the cash transfer occurs directly from within the intercompany components of the enterprise financial application suite. The new feature enables the tracking of intercompany outstanding balance in the intercompany components.

The streamlined connectivity, between Payable, Intercompany, and Cash Management, enhances user experience. It simplifies the process of working with different modules in a cohesive manner.

### Example Applications to Other Domains

While the multi-entity processing system has been described extensively herein with reference to intercompany transactions, the multi-entity processing system is applicable across many domains where data objects (such as documents) call for processing by a plurality of entities. Examples of applications of the multi-entity processing system in other domains follow.

Healthcare Data Exchange and Clinical Workflow Processing. In one embodiment, the multi-entity processing system is applied to healthcare environments, where a patient record or clinical order implicates multiple institutions such as hospitals, laboratories, and insurance providers. The system parses the clinical order (e.g., encoded in HL7 or FHIR formats), detects identifiers corresponding to multiple participating entities, and determines applicable data sharing agreements or care coordination protocols. The system generates execution steps according to sequential and parallel dependencies defined by the clinical workflow, such as routing diagnostic results to both the ordering physician and the insurer. Electronic records are generated in each institution's system of record to maintain synchronized views of the patient's care episode.

Supply Chain Coordination Across Multiple Vendors and Logistics Providers. In one embodiment, the multi-entity processing system is employed for supply chain transactions involving manufacturers, distributors, and logistics firms. A purchase order document is parsed to extract supplier identifiers, carrier references, and warehouse codes, thereby detecting multi-party participation. Agreement data structures represent vendor contracts, service level agreements, or freight terms. The system generates execution steps such as sequential order fulfillment and parallel shipment notifications. Records are generated in supplier ERP systems, carrier logistics platforms, and customer procurement systems to maintain synchronized order and shipment statuses.

Telecommunications Service Provisioning Across Carrier Networks. In one embodiment, the multi-entity processing system is adapted for telecommunications provisioning, where a subscriber order involves multiple carriers in different jurisdictions. A service activation request document is parsed to detect carrier codes and endpoint identifiers, and the system matches attributes of the request to inter-carrier agreements defining roaming, billing, and service quality obligations. The system produces execution steps to configure network elements in parallel across the carriers while enforcing sequential dependencies such as authentication before data provisioning. Each carrier's billing and network management system receives synchronized records reflecting the completed provisioning transaction.

Cloud Computing Resource Planning Across Federated Service Providers. In one embodiment, the multi-entity processing system operates in cloud computing environments where a resource request implicates multiple federated providers. The system parses resource request descriptors (e.g., YAML or JSON deployment manifests), detects references to multiple service providers, and determines federation agreements defining capacity allocation and billing policies. The system generates execution steps that provision compute, storage, or networking resources in parallel across providers while maintaining sequential dependencies for interconnect configuration. Each provider's management console receives generated records documenting the resource allocation for cost tracking and compliance.

Government Inter-Agency Data Sharing and Compliance Processing. In one embodiment, the multi-entity processing system is employed in government workflows requiring inter-agency coordination. A regulatory filing or citizen application document is parsed to detect identifiers for multiple responsible agencies. Agreement data structures correspond to memoranda of understanding or statutory mandates that define the data routing and compliance steps. The system generates execution steps that route the filing sequentially to certain agencies for approval, while distributing informational copies in parallel to others for record-keeping. Records are generated in each agency's system to provide synchronized compliance status.

Insurance Claim Processing Across Insurers, Reinsurers, and Healthcare Providers. In one embodiment, the multi-entity processing system supports insurance claim processing where a single claim implicates a healthcare provider, a primary insurer, and one or more reinsurers. Claim forms (e.g., in EDI or XML formats) are parsed to detect policy numbers and entity identifiers. Agreement data structures encode reimbursement agreements and reinsurance treaties. The system produces execution steps including sequential review by the provider and insurer, with parallel notifications to reinsurers. Records are generated in provider billing systems, insurer adjudication systems, and reinsurer financial systems to maintain synchronized claim status and settlement amounts.

Cross-Platform Digital Media Licensing and Royalty Settlement. In one embodiment, the multi-entity processing system is used for digital media licensing transactions where usage reports implicate multiple publishers, rights holders, and distributors. The system parses usage logs to detect identifiers for multiple rights holders and matches them to stored licensing agreements and royalty share structures. The system computes royalty splits in parallel and sequentially routes settlement instructions to publisher and distributor financial systems. Records are generated in the systems of all parties to maintain synchronized licensing and royalty settlement information.

### Cloud or Enterprise Embodiments

In one embodiment, the multi-entity processing is a computing/data processing system including a computing application or collection of distributed computing applications for access and use by other client computing devices that communicate with the present system over a network. In one embodiment, the multi-entity processing is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, the multi-entity processing is a centralized server-side application that provides at least the functions disclosed herein and that is accessed by many users by way of computing devices/terminals communicating with the computers of the multi-entity processing (functioning as one or more servers) over a computer network. In one embodiment the multi-entity processing may be implemented by a server or other computing device configured with hardware and software to implement the functions and features described herein.

In one embodiment, the components of the multi-entity processing may be implemented as sets of one or more software modules executed by one or more computing devices specially configured for such execution. In one embodiment, the components of the multi-entity processing are implemented on one or more hardware computing devices or hosts interconnected by a data network. For example, the components of the multi-entity processing may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of the multi-entity processing intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of multi-entity processing may (i) generate or compose an electronic message or signal to issue a command or request to another component, (ii) transmit the message or signal to other components of the multi-entity processing, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by the multi-entity processing, for example through a web interface server. In one embodiment, the remote computing system may send requests to and receive responses from the multi-entity processing. In one example, access to the information or applications may be effected through use of a web browser on a personal computer or mobile device. In one example, communications exchanged with the multi-entity processing may take the form of remote representational state transfer (REST) requests using JavaScript object notation (JSON) as the data interchange format for example, or simple object access protocol (SOAP) requests to and from XML servers. The REST or SOAP requests may include API calls to components of the multi-entity processing

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

### Computing Device Embodiment

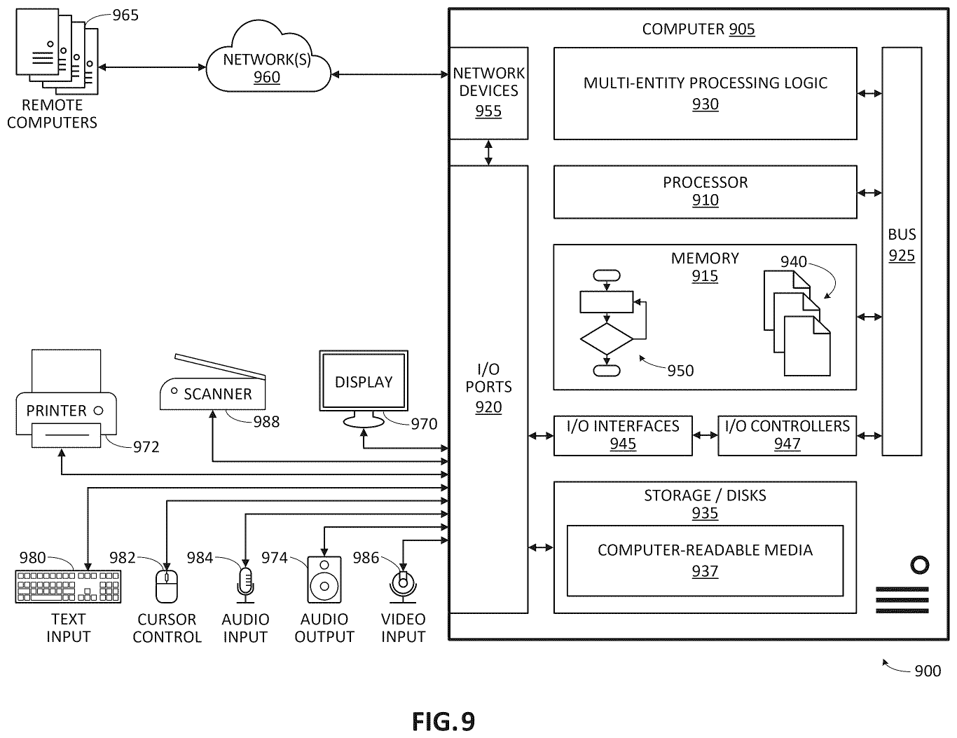

FIG. 9 illustrates an example computing system 900 that is configured and/or programmed as a special purpose computing device(s) with one or more of the example systems and methods described herein, and/or equivalents. The example computing device may be a computer 905 that includes at least one hardware processor 910, a memory 915, and input/output ports 920 operably connected by a bus 925. In one example, the computer 905 may include multi-entity processing logic 930 configured to facilitate autonomous preparation of inter-entity electronic documents, similar to the logic, systems, methods, and other embodiments described herein and shown in FIGS. 1-8.

In different examples, the logic 930 may be implemented in hardware, one or more non-transitory computer-readable media 937 with stored instructions, firmware, and/or combinations thereof. While the logic 930 is illustrated as a hardware component attached to the bus 925, it is to be appreciated that in other embodiments, the logic 930 could be implemented in the processor 910, stored in memory 915, or stored in disk 935.

In one embodiment, logic 930 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate complete automation of intercompany expenses. The means may also be implemented as stored computer executable instructions that are presented to computer 905 as data 940 that are temporarily stored in memory 915 and then executed by processor 910.

Logic 930 may also provide means (e.g., hardware, non-transitory computer-readable medium that stores executable instructions, firmware) for performing one or more of the disclosed functions and/or combinations of the functions.

Generally describing an example configuration of the computer 905, the processor 910 may be a variety of various processors including dual microprocessor and other multi-processor architectures. A memory 915 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 935 may be operably connected to the computer 905 via, for example, an input/output (I/O) interface (e.g., card, device) 945 and an input/output port 920 that are controlled by at least an input/output (I/O) controller 947. The disk 935 may be, for example, a magnetic disk drive, a solid-state drive, a floppy disk drive, a tape drive, a Zip drive, a flash memory card, a memory stick, and so on. Furthermore, the disk 935 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 915 can store a process 950 and/or a data 940, for example. The disk 935 and/or the memory 915 can store an operating system that controls and allocates resources of the computer 905.

The computer 905 may interact with, control, and/or be controlled by input/output (I/O) devices via the input/output (I/O) controller 947, the I/O interfaces 945, and the input/output ports 920. Input/output devices may include, for example, one or more network devices 955, displays 970, printers 972 (such as inkjet, laser, or 3D printers), audio output devices 974 (such as speakers or headphones), text input devices 980 (such as keyboards), cursor control devices 982 for pointing and selection inputs (such as mice, trackballs, touch screens, joysticks, pointing sticks, electronic styluses, electronic pen tablets), audio input devices 984 (such as microphones or external audio players), video input devices 986 (such as video and still cameras, or external video players), image scanners 988, video cards (not shown), disks 935, and so on. The input/output ports 920 may include, for example, serial ports, parallel ports, and USB ports.

The computer 905 can operate in a network environment and thus may be connected to the network devices 955 via the I/O interfaces 945, and/or the I/O ports 920. Through the network devices 955, the computer 905 may interact with a network 960. Through the network 960, the computer 905 may be logically connected to remote computers 965. Networks with which the computer 905 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computing system, comprising:
at least one processor connected to at least one memory;
one or more non-transitory computer-readable media including instructions stored thereon that when executed by at least the processor cause the computing system to:
parse data of a document being processed in a processing flow for a first entity to extract attributes of the document and detect that the document also concerns a second entity based on the attributes;
determine, in response to the detection, an inter-entity agreement that governs processing between the first entity and second entity by matching one or more of the attributes of the document against stored agreement data structures;
automatically orchestrate processing of a transaction between the first entity and the second entity by generating execution steps according to sequential and parallel dependencies specified by the inter-entity agreement; and
generate, based on the attributes and additional attributes from other data sources, electronic records in a system of the first entity and a system of the second entity that reflect execution of the transaction.

2. The computing system of claim 1, wherein the instructions further cause the computing system to, where attributes used for the processing of the transaction are missing:
enqueue the document into a deferred processing queue until the missing attributes are populated;
collect one or more of the missing attributes from one or more other documents in other systems; and
infer one or more of the missing attributes based at least in part on the collected attributes using a machine learning model.

3. The computing system of claim 1, wherein the instructions to determine the inter-entity agreement further cause the computing system to select the inter-entity agreement from among other agreements based at least in part on contents of the of the document and patterns derived from historical documents and agreements associated with the historical documents.

4. The computing system of claim 1, wherein the instructions to orchestrate processing of the transaction further cause the computing system to generate a directed acyclic graph of the sequential and parallel tasks derived from the inter-entity agreement.

5. The computing system of claim 1, wherein the instructions further cause the computing system to populate one or more missing attributes for the processing of the transaction by inference based on one or more of the populated attributes.

6. The computing system of claim 1, wherein the instructions to generate the electronic records further causes the computing system to initiate a settlement instruction by transmitting a bank transfer request to a cash management system.

7. The computing system of claim 1, wherein the instructions further cause the computing system to enforce idempotent processing across multi-entity transaction flows by:
assigning an idempotency key to the document upon ingestion;
reconciling duplicate submissions and partial writes associated with the idempotency key to a single outcome;
preventing duplicate creation of intercompany records in systems of the first entity and the second entity; and
maintaining immutable lineage links between the document, the inter-entity agreement, intercompany transactions, and settlement records to ensure retries preserve a consistent end-to-end state.

8. A computer-implemented method, comprising:
parsing data of a document being processed in a processing flow for a first entity to extract attributes of the document and detect that the document also concerns a second entity based on the attributes;
determining, in response to the detection, an inter-entity agreement that governs processing between the first entity and second entity by matching one or more of the attributes of the document against stored agreement data structures;
automatically orchestrating processing of an inter-company transaction between the first entity and the second entity by generating execution steps according to sequential and parallel dependencies specified by the inter-entity agreement; and
generating, based on the attributes and additional attributes from other data sources, electronic records in a system of the first entity and a system of the second entity that reflect execution of the inter-company transaction.

9. The computer-implemented method of claim 8, where attributes used for the processing of the inter-company transaction are missing, the method further comprises:
enqueueing the document into a deferred processing queue until the missing attributes are populated;
collecting one or more of the missing attributes from one or more other documents in other systems; and
inferring one or more of the missing attributes based at least in part on the collected attributes using a machine learning model.

10. The computer-implemented method of claim 8, further comprising selecting the inter-entity agreement from among other agreements based at least in part on contents of the document and patterns derived from historical documents and agreements associated with the historical documents.

11. The computer-implemented method of claim 8, wherein orchestrating processing of the inter-company transaction further comprises generating a directed acyclic graph of the sequential and parallel tasks derived from the inter-entity agreement.

12. The computer-implemented method of claim 8, further comprising populating one or more missing attributes for the processing of the inter-company transaction by inference based on one or more of the populated attributes.

13. The computer-implemented method of claim 8, wherein generating the electronic records further comprises initiating a settlement instruction by transmitting a bank transfer request to a cash management system.

14. The computer-implemented method of claim 8, further comprising enforcing idempotent processing across multi-entity transaction flows by:
assigning an idempotency key to the document upon ingestion;
reconciling duplicate submissions and partial writes associated with the idempotency key to a single outcome;
preventing duplicate creation of intercompany records in systems of the first entity and the second entity; and
maintaining immutable lineage links between the document, the inter-entity agreement, intercompany transactions, and settlement records to ensure retries preserve a consistent end-to-end state.

15. One or more non-transitory computer-readable media including instructions stored thereon that when executed by at least a processor of a computing system cause the computing system to:
parse an electronic document being processed in a processing flow for a first entity to detect that the document also concerns a second entity based on attributes of the document;
determine, in response to the detection, an inter-entity agreement that governs processing between the first entity and second entity by matching one or more of the attributes of the document against stored agreement data structures;
automatically orchestrate processing of an inter-company transaction between the first entity and the second entity by generating execution steps according to sequential and parallel dependencies specified by the inter-entity agreement; and
generate, based on the attributes and additional attributes from other data sources, electronic records in a system of the first entity and a system of the second entity that reflect execution of the inter-company transaction.

16. The non-transitory computer-readable media of claim 15, wherein the instructions further cause the computing system to, where attributes used for the processing of the inter-company transaction are missing:
enqueue the document into a deferred processing queue until the missing attributes are populated;
collect one or more of the missing attributes from one or more other documents in other systems; and
infer one or more of the missing attributes from the collected attributes.

17. The non-transitory computer-readable media of claim 15, wherein the instructions to determine the inter-entity agreement further cause the computing system to select the inter-entity agreement from among other agreements based at least in part on contents of the of the document and patterns derived from historical documents and agreements associated with the historical documents.

18. The non-transitory computer-readable media of claim 15, wherein the instructions further cause the computing system to populate one or more missing attributes for the processing of the inter-company transaction by inference based on one or more of the populated attributes.

19. The non-transitory computer-readable media of claim 15, wherein the instructions further cause the computing system to populate one or more missing attributes for the processing of the inter-company transaction by retrieval from a plurality of discrete systems.

20. The non-transitory computer-readable media of claim 15, wherein the instructions further cause the computing system to enforce idempotent processing across multi-entity transaction flows.
